(19) United States
(12) Patent Application Publication
(10) Pub. No.: US 2023/0097103 A1
(43) Pub. Date: Mar. 30, 2023

(54) FAST FOURIER TRANSFORM USING PHASOR TABLE

(71) Applicant: QUALCOMM Incorporated, San Diego, CA (US)

(72) Inventors: Santosh Srivatsan Srinivasan, San Diego, CA (US); Marc Hoffman, Mansfield, MA (US); Srijesh Sudarsanan, Boston, MA (US); Deepak Mathew, Acton, MA (US); Hongfeng Dong, Acton, MA (US); Gerald Sweeney, Chelmsford, MA (US)

(21) Appl. No.: 17/448,810

(22) Filed: Sep. 24, 2021

(51) Int. Cl. G06F 17/14; G06F 9/30

(52) U.S. Cl. CPC G06F 17/142; G06F 9/30101; G06F 9/30036

(57) ABSTRACT

A device includes a memory configured to store a fast Fourier transform (FFT) instruction and parameters of the FFT instruction, a read-only memory including a phasor table, and a processor. The processor is configured to execute the FFT instruction to determine, based on the parameters of the FFT instruction, a start value and a step size. The processor is configured to execute the FFT instruction to access the phasor table according to the start value and the step size to obtain a set of twiddle values. The processor is also configured to execute the FFT instruction to compute, for each pair of input values in a set of input data, an output value based on the pair of input values and a twiddle value, of the set of twiddle values, that corresponds to that pair of input values.

### I. FIELD

The present disclosure is generally related to performing fast Fourier transforms.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to perform signal processing operations. For example, processors in wireless telephones may be adapted to convert input signals from a time domain to a frequency domain, process the input signals in the frequency domain, and convert the processed signals back to the time domain. A Fourier transform is a mathematical algorithm for converting a signal from a time domain to a frequency domain. A fast Fourier transform (FFT) is an efficient algorithm for computing a discrete Fourier transform (DFT) of digitized time domain input signals. A set of data (i.e., input signals) in the time domain may be converted to the frequency domain using a FFT for further signal processing and then converted back to the time domain (e.g., using an inverse FFT (IFFT) operation).

Performance of an FFT operation may be improved by using a divide-and-conquer approach to reduce the number of computations. One such approach is known as a radix-2 algorithm. The radix-2 algorithm takes input data samples two at a time when computing the FFT and uses a set of twiddle factors (i.e., complex multiplicative constants) during the calculations. For example, performing a radix-2 FFT on 128 input samples (i.e. a 128-point FFT operation) includes 7 stages of computation. Conventionally, tables of twiddle factors are stored to support FFT computations for each FFT size and for each stage of computation. Such twiddle factor tables are typically stored in local memory, hardware read-only memory, or both. Storing a large number of twiddle factor tables for each FFT size and each stage of computation increases memory usage, hardware area associated with read-only memory, vector register pressure (e.g., reduced availability of free physical vector registers) and code size for supporting loading and managing specific twiddle factors from memory, or a combination thereof.

### III. SUMMARY

According to one implementation of the present disclosure, a device includes a memory configured to store a fast Fourier transform (FFT) instruction and parameters of the FFT instruction, a read-only memory including a phasor table, and a processor. The processor is configured to execute the FFT instruction to determine, based on the parameters of the FFT instruction, a start value and a step size. The processor is configured to execute the FFT instruction to access the phasor table according to the start value and the step size to obtain a set of twiddle values. The processor is also configured to execute the FFT instruction to compute, for each pair of input values in a set of input data, an output value based on the pair of input values and a twiddle value, of the set of twiddle values, that corresponds to that pair of input values.

According to another implementation of the present disclosure, a method of executing a fast Fourier transform (FFT) instruction includes determining, at a processor, a start value and a step size based on parameters of the FFT instruction. The method includes accessing a phasor table at a read-only memory according to the start value and the step size to obtain a set of twiddle values. The method also includes computing, at the processor and for each pair of input values in a set of input data, an output value based on the pair of input values and a twiddle value, of the set of twiddle values, that corresponds to that pair of input values.

According to another implementation of the present disclosure, a non-transitory computer-readable medium stores instructions that, when executed by one or more processors, cause the one or more processors to, during execution of a fast Fourier transform (FFT) instruction, determine a start value and a step size based on parameters of the FFT instruction. The instructions, when executed by the one or more processors, cause the one or more processors to, during execution of the FFT instruction, access a phasor table at a read-only memory according to the start value and the step size to obtain a set of twiddle values. The instructions, when executed by the one or more processors, also cause the one or more processors to, during execution of the FFT instruction, compute, for each pair of input values in a set of input data, an output value based on the pair of input values and a twiddle value, of the set of twiddle values, that corresponds to that pair of input values.

According to another implementation of the present disclosure, an apparatus includes means for determining a start value and a step size based on parameters of a fast Fourier transform instruction. The apparatus includes means for accessing a phasor table at a read-only memory according to the start value and the step size to obtain a set of twiddle values. The apparatus also includes means for computing, for each pair of input values in a set of input data, an output value based on the pair of input values and a twiddle value, of the set of twiddle values, that corresponds to that pair of input values.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to perform fast Fourier transforms using a phasor table, in accordance with some examples of the present disclosure.

FIG. 2 is a diagram of a particular implementation of operations and components that may be included in the system of FIG. 1, in accordance with some examples of the present disclosure.

FIG. 3 is a diagram of a particular implementation of components that may be included in the system of FIG. 1, in accordance with some examples of the present disclosure.

FIG. 4 is a diagram of another particular implementation of components that may be included in the system of FIG. 1, in accordance with some examples of the present disclosure.

FIG. 5 is a diagram of a particular implementation of a multi-stage fast Fourier transform operation that may be performed by the system of FIG. 1, in accordance with some examples of the present disclosure.

FIG. 6A is a diagram of a particular implementation of a non-consecutive twiddle register consumption order that may be implemented by the system of FIG. 1, in accordance with some examples of the present disclosure.

FIG. 6B is a diagram of another particular implementation of a non-consecutive twiddle register consumption order that may be implemented by the system of FIG. 1, in accordance with some examples of the present disclosure.

FIG. 7 illustrates an example of an integrated circuit operable to perform fast Fourier transforms using a phasor table, in accordance with some examples of the present disclosure.

FIG. 8 is a diagram of a mobile device operable to perform fast Fourier transforms using a phasor table, in accordance with some examples of the present disclosure.

FIG. 9 is a diagram of a headset operable to perform fast Fourier transforms using a phasor table, in accordance with some examples of the present disclosure.

FIG. 10 is a diagram of a wearable electronic device operable to perform fast Fourier transforms using a phasor table, in accordance with some examples of the present disclosure.

FIG. 11 is a diagram of a voice-controlled speaker system operable to perform fast Fourier transforms using a phasor table, in accordance with some examples of the present disclosure.

FIG. 12 is a diagram of a camera operable to perform fast Fourier transforms using a phasor table, in accordance with some examples of the present disclosure.

FIG. 13 is a diagram of a headset, such as a virtual reality or augmented reality headset, operable to perform fast Fourier transforms using a phasor table, in accordance with some examples of the present disclosure.

FIG. 14 is a diagram of a first example of a vehicle operable to perform fast Fourier transforms using a phasor table, in accordance with some examples of the present disclosure.

FIG. 15 is a diagram of a second example of a vehicle operable to perform fast Fourier transforms using a phasor table, in accordance with some examples of the present disclosure.

FIG. 16 is a diagram of a particular implementation of a method of performing fast Fourier transforms using a phasor table that may be performed by the device of FIG. 1, in accordance with some examples of the present disclosure.

FIG. 17 is a diagram of another particular implementation of a system operable to perform fast Fourier transforms using a phasor table, in accordance with some examples of the present disclosure.

FIG. 18 is a block diagram of a particular illustrative example of a device that is operable to perform fast Fourier transforms using a phasor table, in accordance with some examples of the present disclosure.

### V. DETAILED DESCRIPTION

Systems and methods of performing FFTs using a phasor table are described. Conventionally, supporting FFT computations for multiple FFT sizes requires maintaining tables of stored twiddle factors for each FFT size and for each stage of computation. Storing a large number of twiddle factor tables for each FFT size and each stage of computation increases memory usage, hardware area associated with read-only memory (ROM), vector register pressure and code size for supporting loading and managing specific twiddle factors from memory, or a combination thereof.

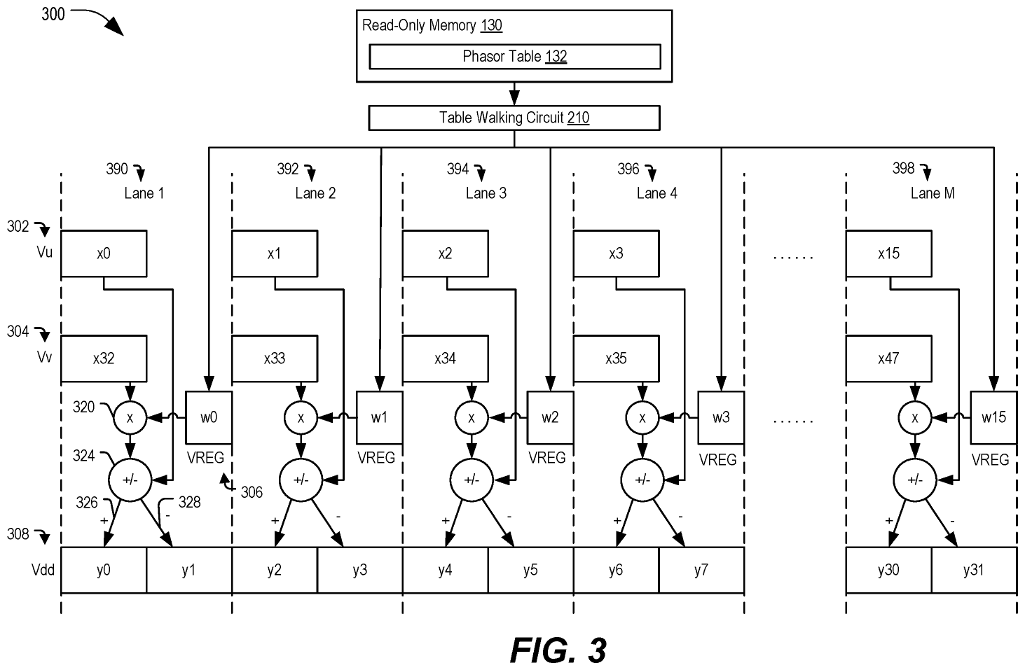

The disclosed systems and methods access a phasor table, such as a shared, general-purpose phasor table in ROM, to determine twiddle factors (also referred to herein as “twiddle values”) for FFT operations. A look-up pattern to retrieve the twiddle values from the phasor table is determined, per lane and per stage (such as described further with reference to FIGS. 3-5), based on parameters of an FFT instruction. According to some aspects, the look-up pattern is specified by parameters in a scalar register pair that is identified as an input of the FFT instruction. For example, the parameters can be used to determine a start value and a step size to sequentially access twiddle values from the phasor table for use with a particular FFT size and stage of computation.

Obtaining twiddle values from the phasor table instead of using specialized twiddle tables stored in local memory or in ROM enables reduced vector register pressure and code size by eliminating loading and managing specific twiddle values from memory. Eliminating maintenance of multiple twiddle factor tables reduces local memory usage, and hardware area usage can be reduced by eliminating twiddle tables stored in the ROM. Additionally, including a shift schedule for the FFT computation per-stage in the parameters of the FFT instruction enables a unified FFT implementation for each FFT size using programmable shift schedules, resulting in memory savings due to reduced code size.

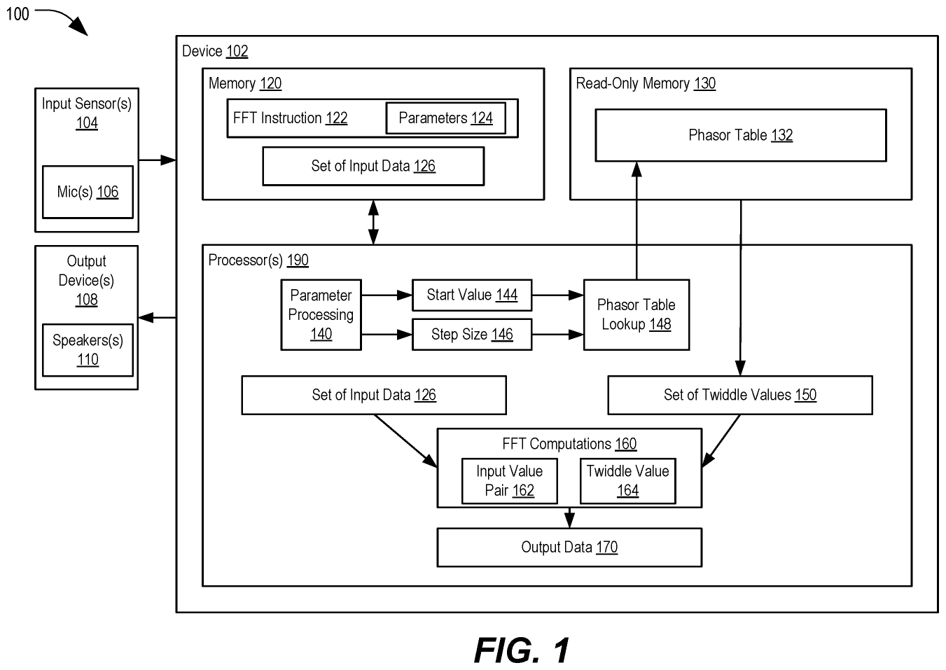

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 190 of FIG. 1), which indicates that in some implementations the device 102 includes a single processor 190 and in other implementations the device 102 includes multiple processors 190. For ease of reference herein, such features are generally introduced as “one or more” features and are subsequently referred to in the singular unless aspects related to multiple of the features are being described.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

Referring to FIG. 1, a particular illustrative aspect of a system configured to perform fast Fourier transforms using a phasor table is disclosed and generally designated 100. The system 100 includes a device 102 that includes one or more processors 190. The processor 190 is configured to execute an FFT instruction 122 that includes obtaining a set of twiddle values 150 from a phasor table 132 at a read-only memory 130. In some implementations, the device 102 is coupled to one or more input sensors 104, such as one or more microphones (mic(s)) 106, and to one or more output devices 108, such as one or more loudspeakers 110. In a particular implementation, the microphone 106, the loudspeaker 110, or both are external to the device 102. In an alternative implementation, the microphone 106, the loudspeaker 110, or both are integrated in the device 102.

The device 102 includes a memory 120 and the read-only memory 130 coupled to the processor 190. The memory 120 is configured to store the FFT instruction 122. In some implementations, the memory 120 is configured to store a set of input data 126 to be processed during execution of the FFT instruction 122.

In some implementations, the phasor table 132 includes entries representing complex numbers associated with equally-sized angle increments. In an illustrative, non-limiting example, the phasor table 132 includes entries of the form:

$$Cos ( \frac{π}{4} \cdot \frac{1}{512} \cdot i ) , Sin ( \frac{π}{4} \cdot \frac{1}{512} \cdot i ) for all i ∈ \{ 1 , 3 , 5 , … , 511 \} ,$$

thus including 256 entries for angles in one octant (π/4). In an illustrative implementation, the phasor table 132 includes 256 entries for angles in one octant (e.g., one entry for each value of i=1, 3, 5, . . . 511). In another implementation, the phasor table includes 512 entries for angles in one octant that may be obtained by dividing the octant into 512 quantized bins, and twiddle values are selected from a subset of the table entries (e.g., the 256 odd entries for the octant).

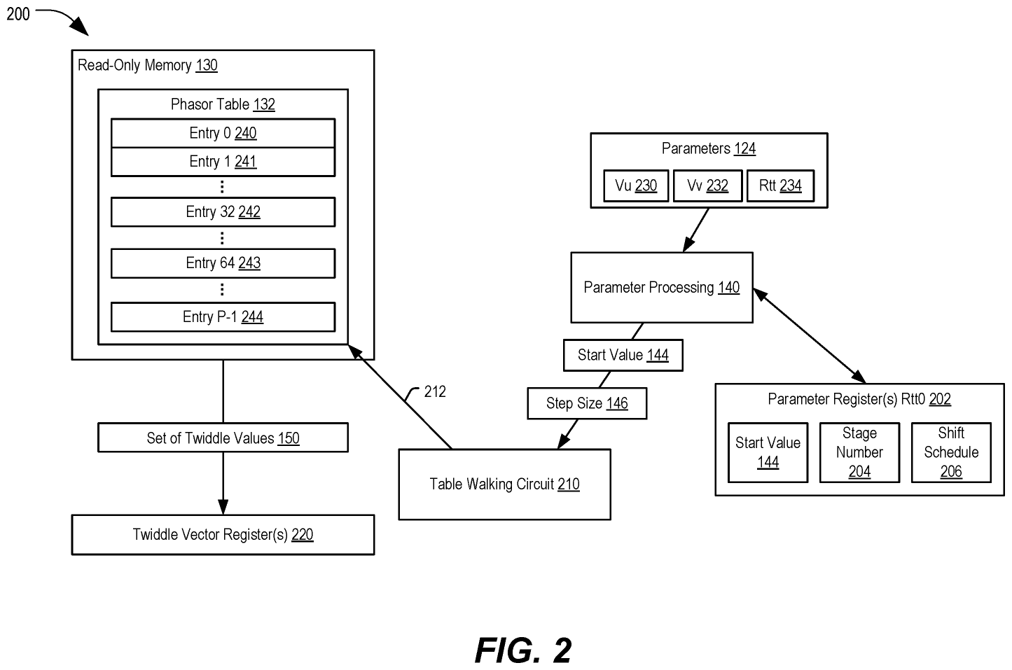

The processor 190 is configured to execute the FFT instruction 122 to determine, based on parameters 124 of the FFT instruction 122, a start value 144 and a step size 146. To illustrate, execution of the FFT instruction 122 includes a parameter processing operation 140 that processes the parameters 124 to generate the start value 144 and the step size 146, such as described in further detail with reference to FIG. 2. For example, the FFT instruction 122 may correspond to a “r2fftnn” instruction, where “r2fft” indicates that a radix-2 FFT algorithm is implemented (i.e., two samples are taken at a time from the set of input data 126), and where “nn” indicates that the FFT instruction 122 accepts the inputs in a normal order (e.g., in a sequential order) and outputs data in the normal order. The FFT instruction 122 may have the form

Vd=r2fftnn(Vu, Vv, Rtt),

where Vd is a destination vector register, Vu and Vv are source registers containing input data, and Rtt is a scalar register pair that includes control values, as described in further detail with reference to FIG. 2. Although examples herein describe the FFT instruction 122 as a r2fftnn instruction, in other implementations the FFT instruction 122 is a “r2fftnb” instruction of the form Vd=r2fftnb(Vu, Vv, Rtt), where “nb” indicates that the FFT instruction 122 accepts the inputs in a normal order and outputs data in a bit-reversed order. Although examples herein describe the FFT instruction 122 as corresponding to radix-2 FFT computations, in other implementations the FFT instruction 122 is applicable for mixed-radix FFT computations of any size.

Execution of the FFT instruction 122 at the processor 190 also includes accessing the phasor table 132 according to the start value 144 and the step size 146 to obtain the set of twiddle values 150. To illustrate, the processor 190 may perform a phasor table lookup operation 148 that generates a sequence of phasor identifiers (e.g., locations or indices of phasor values in the phasor table 132), starting with the start value 144 and incrementing by the step size 146 to identify each subsequent phasor value in the sequence. The phasors identified by the generated sequence correspond to twiddle values to be used during execution of the FFT instruction 122. The phasor table lookup operation 148 includes sending the sequence of phasor identifiers (e.g., the locations or indices of phasor values) to the phasor table 132, and the corresponding phasor values are obtained from the phasor table 132 as the set of twiddle values 150.

To illustrate, twiddle factors for butterfly computations (e.g., computations that combine the results of smaller DFTs into a larger DFT) of a radix-2 FFT of size N can be defined as:

$${W}_{N} [ k ] = {e}^{- j \frac{2 π bitrev ( k )}{N}} ,$$

where bitrev(*) denotes a bit reversal operation. Alternatively, the bit reversal operation can be applied to the input vector sequence using vector permutation, resulting in the twiddle factors:

$${W}_{N} [ k ] = {e}^{- j \frac{2 π k}{N}} = Cos ( \frac{2 π k}{N} ) + j Sin ( \frac{2 π k}{N} ) .$$

Thus, entries in the phasor table 132 that match the twiddle factors W_{N}[k] for a particular FFT operation can be identified and retrieved from the phasor table 132 to form the set of twiddle values 150.

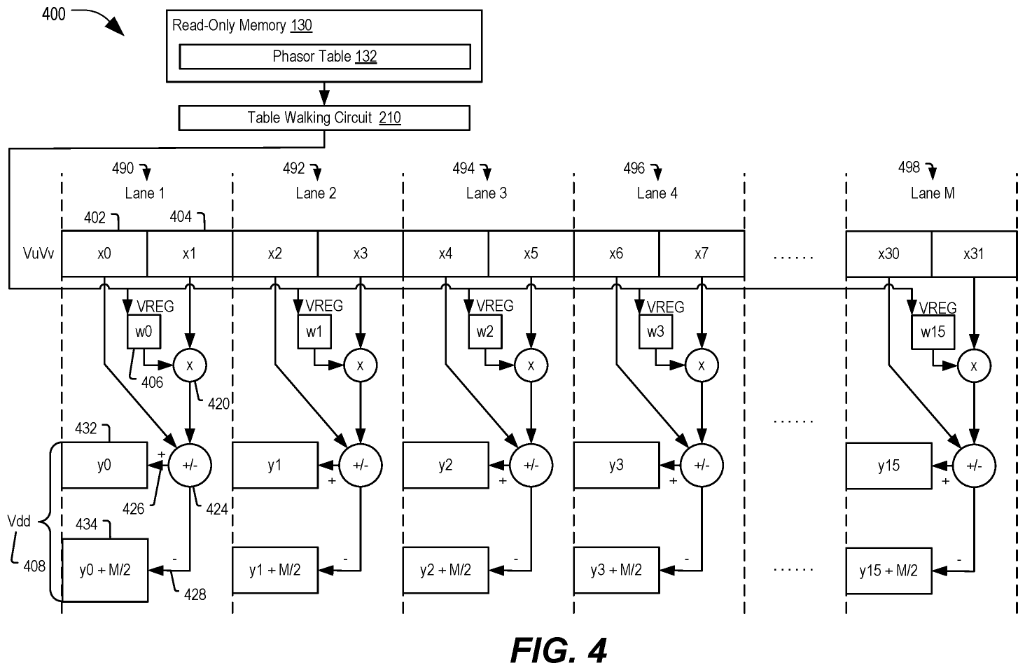

Execution of the FFT instruction 122 at the processor 190 also includes computing, for each pair of input values in the set of input data 126, an output value based on the pair of input values and based on a twiddle value, of the set of twiddle values 150, that corresponds to that pair of input values. To illustrate, in some implementations the processor 190 is a single instruction multiple data (SIMD) processor that performs multiple FFT computations 160 in parallel as part of executing the FFT instruction 122. Each of the FFT computations 160 operates on a pair of values from the input data 126 and on one of the twiddle values of the set of twiddle values 150, illustrated as a representative input value pair 162 and a representative twiddle value 164, to generate a pair of output values that form part of the output data 170. Illustrative examples of the FFT computations 160 in a SIMD architecture are described in further detail with reference to FIG. 3 and FIG. 4.

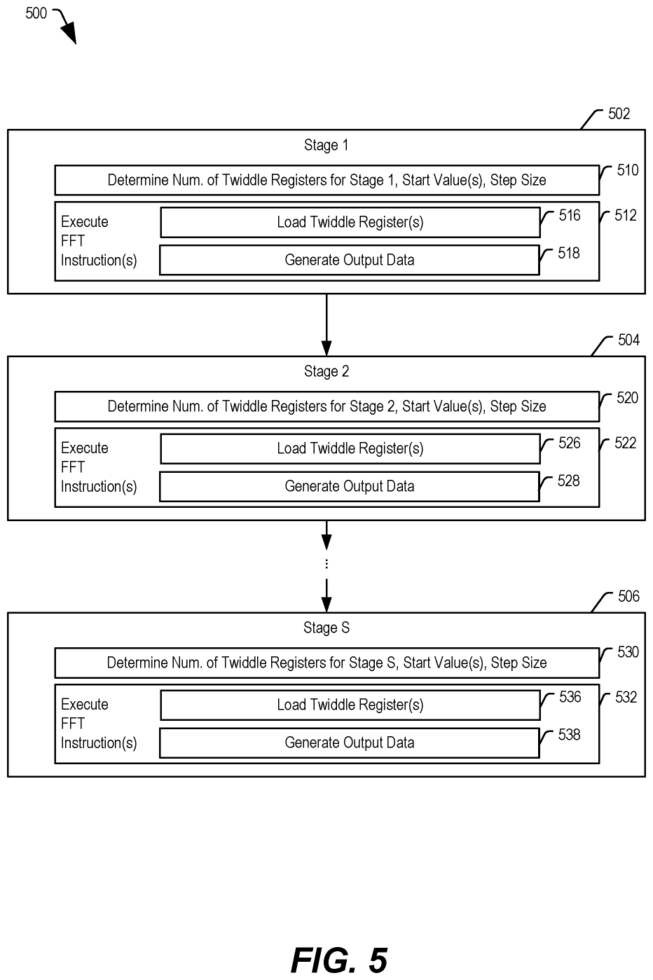

In some implementations, the processor 190 is configured to execute the FFT instruction 122 as part of a multi-stage FFT operation. For example, one or more instances of the FFT instruction 122 may be executed for each stage of the multi-stage FFT operation in which the output data 170 of one stage is used as the input data 126 of the next stage. One or more of the parameters 124, such as the step size 146, may be updated for each stage (and, in some instances, for each portion of a stage). An example of a multi-stage FFT operation is described in further detail with reference to FIG. 5.

The input data 126 may include time-domain data from the input sensor 104, such as audio data samples from the microphone 106, that is processed, using the FFT instruction 122, to generate the output data 170 in the frequency domain. The output data 170 may be processed (e.g., to perform noise reduction, feature extraction, etc.) to support audio operations at the device 102, such as audio operations corresponding to a speech interface, telephony or teleconferencing, or virtual reality or augmented reality applications, as illustrative, non-limiting examples. Alternatively, in implementations in which the FFT instruction 122 is used in conjunction with an inverse FFT operation, the input data 126 may include frequency-domain data, such as audio frequency data, which is processed to generate the output data 170 in the time domain. The output data 170 may be provided as output to the output device 108, such as for playback at the loudspeaker 110.

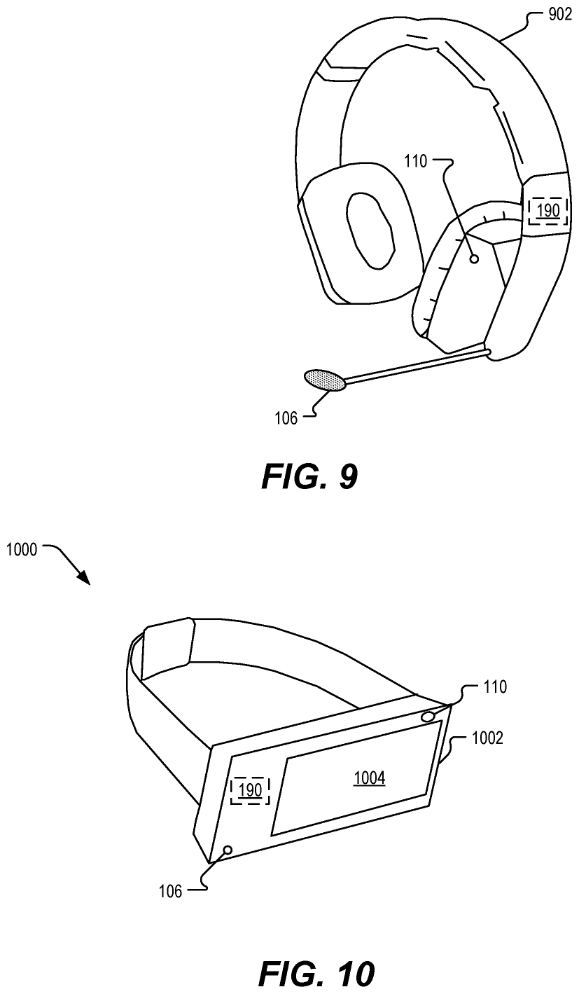

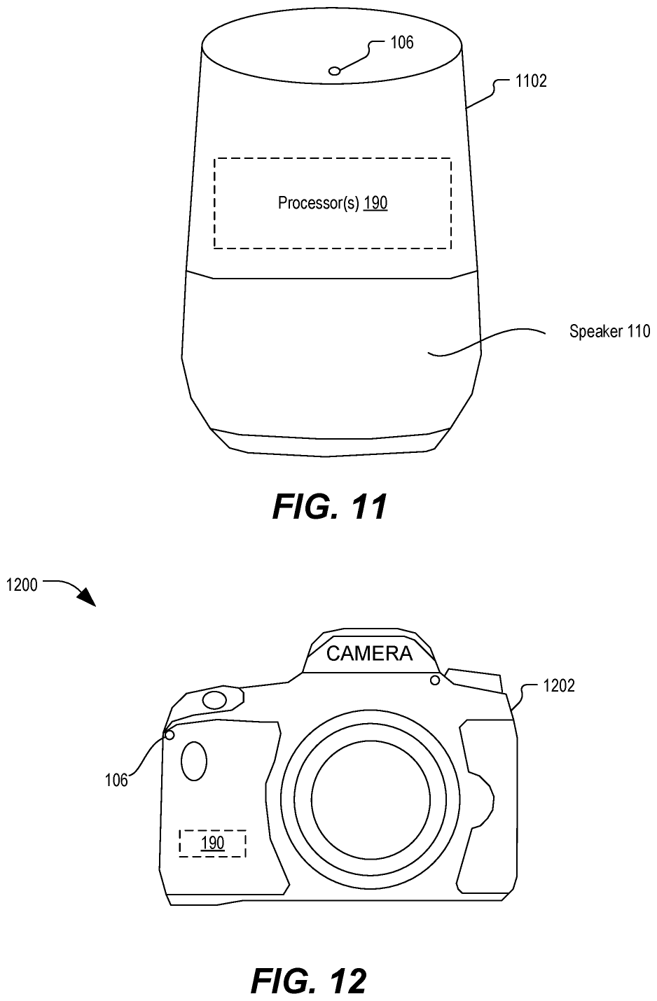

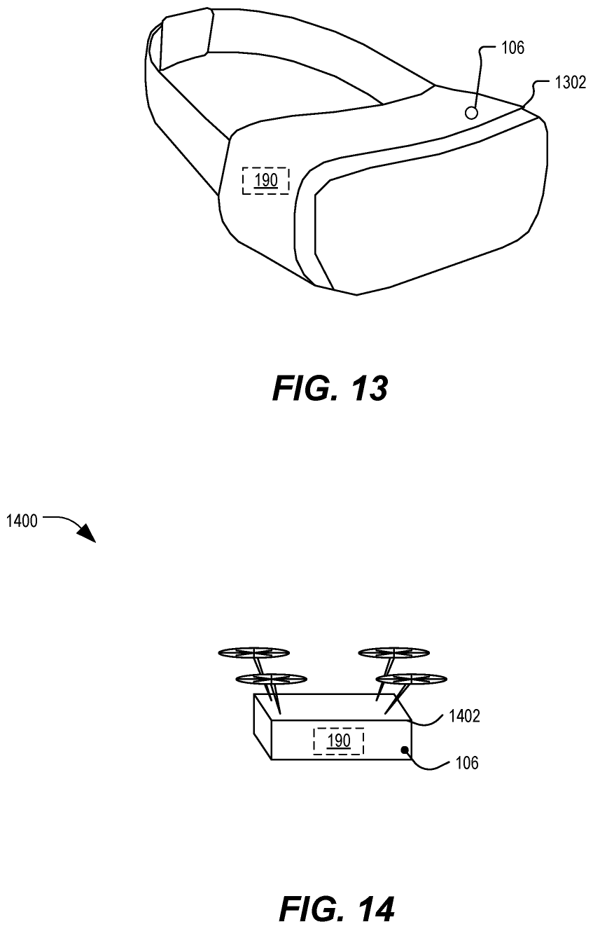

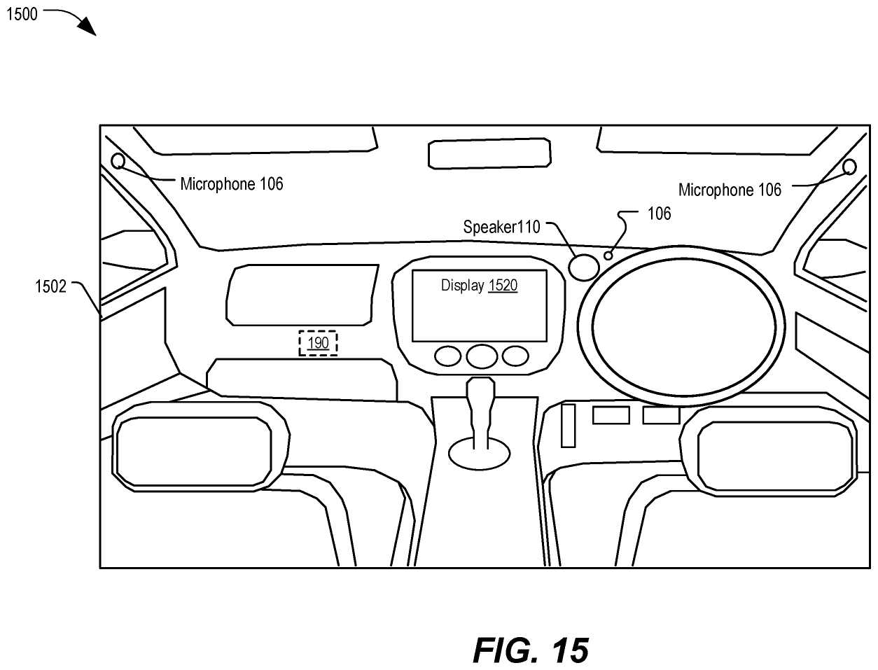

In some implementations, the processor 190 corresponds to or is included in various types of devices. In an illustrative example, the processor 190 is integrated in at least one of a mobile phone or a tablet computer device, as described with reference to FIG. 8. In other examples, the processor 190 is integrated in a headset device, as described with reference to FIG. 9, a wearable electronic device, as described with reference to FIG. 10, a voice-controlled speaker system, as described with reference to FIG. 11, a camera device, as described with reference to FIG. 12, or a virtual reality, augmented reality, or mixed reality headset, as described with reference to FIG. 13. In another illustrative example, the processor 190 is integrated into a vehicle, such as described further with reference to FIG. 14 and FIG. 15.

During operation, in a particular implementation in which the processor 190 is executing program instructions corresponding to a multi-stage FFT operation, the processor 190 initiates execution of the FFT instruction 122 having the parameters 124. The processor 190 performs the parameter processing operation 140 to determine control values including the start value 144 and the step size 146 for retrieving a sequence of values that correspond to twiddle factors for the current stage of the multi-stage FFT operation from the phasor table 132. The phasor table lookup operation 148 retrieves the sequence of values from the phasor table as the set of twiddle values 150.

According to an aspect, the processor 190 performs the FFT computations 160 in parallel. Each of the FFT computations operates on a respective pair of values from the set of input data 126 and uses a respective one of the twiddle values of the set of twiddle values 150 to generate the output data 170.

By obtaining the set of twiddle values 150 from the phasor table 132 instead of using specialized twiddle tables stored in the memory 120 or in the read-only memory 130, vector register pressure and code size associated with loading and managing twiddle values from memory are reduced. Local memory usage and hardware area usage can also be reduced by eliminating twiddle tables stored in the ROM 130 and instead using a general-purpose phasor table. Additionally, as described further with reference to FIG. 2, a shift schedule indicating whether a right shift is performed for each stage of the FFT computation may be included in the parameters 124, enabling a unified FFT implementation for each FFT size using programmable shift schedules, resulting in memory savings due to reduced code size.

Various modifications to the system 100 can be incorporated in accordance with other implementations. For example, although the input sensor 104 includes the microphone 106, in other implementations the input sensor 104 includes one or more other sensors instead of, or in addition to, the microphone 106. For example, the input sensor 104 can include a camera configured to generate image data that can be used in the set of input data 126. In other implementations, the input sensor 104 can be omitted, such as when the set of input data 126 is received from memory or via transmission.

As another example, although the output device 108 includes the loudspeaker 110, in other implementations the output device 108 includes one or more other devices instead of, or in addition to, the loudspeaker 110. For example, the output device 108 can include a display screen configured to display images represented by the output data 170. In other implementations, the output device 108 can be omitted, such as when the output data 170 is consumed by another application of the device 102, stored, or transmitted to another device.

Referring to FIG. 2, an illustrative implementation of operations and components that may be implemented in the processor 190 is shown and generally designated 200.

In the implementation 200, the parameters 124 are received in conjunction with the FFT instruction 122 and correspond to a particular stage of a multi-stage FFT operation. The parameters 124 include an indication (Vu) 230 of a first input vector register that stores a first portion of the set of input data 126 and an indication (Vv) 232 of a second input vector register that stores a second portion of the set of input data 126. To illustrate, the first input vector register and the second input vector registers may be included in the processor 190 of FIG. 1. Examples of the first input vector register and the second input vector register are described with reference to FIG. 3 and FIG. 4.

The parameters 124 also include an indication (Rtt) 234 of a parameter register (Rtt0) 202. The parameter register 202 stores the start value 144 and a stage number 204 of the multi-stage FFT operation and may be included in the processor 190 of FIG. 1. For example, the parameter register 202 can include a scalar register pair that stores the start value 144 (e.g., the starting phase of the twiddle sequence to be retrieved from the phasor table 132) as a first word in a first scalar register and that stores the stage number 204 in a second scalar register.

The parameter register 202 further stores a shift schedule 206 of the multi-stage FFT operation. The shift schedule 206 can include a bitmap that indicates, for each stage of the multi-stage FFT operation, a presence or absence of a shift for that stage. For example, when the FFT operation is performed in S stages (where S is a positive integer), the shift schedule 206 can include a set of bits {b₀, b₁, . . . , b_{S-1}}, where b₀ is a bit indicator for stage 0, b₁ is a bit indicator for stage 1, and b_{S-1} is a bit indicator for stage S-1. A particular bit (e.g., b₁) having a first value (e.g., a 1 value) indicates that a right shift is applied at the stage (e.g., stage 1) associated with that bit, and the bit having a second value (e.g., a 0 value) indicates that the stage associated with that bit does not have a shift. As an illustrative example, the bitmap “0010” indicates that stage 2 has a right shift and that stages 0, 1, and 3 do not.

In an illustrative example, the first word (denoted Rtt.w[0]) in the parameter register 202 indicates the start value 144. The next half-word (denoted Rtt.h[2]) in the parameter register 202 specifies the stage number 204 as log₂(N), where the relationship between the FFT size N and the stage number s is given as N=2^{s}. The final half-word (denoted Rtt.h[3]) contains the shift schedule 206 in the form of a bitmap.

The parameter processing operation 140 is configured to determine the step size 146 based on the stage number 204. In an illustrative example, the step size (rxt) 146 is −2π/N, which can be computed as:

rxt=MINUS_PI>>(log 2N−1),

where MINUS_PI has a value of −π, log 2N represents log₂(N) and corresponds to the stage number 204, and “>>” represents a right-shift operation (e.g., A>>B equals A/2^{B}).

In some implementations, the parameter processing operation 140 generates a shift flag as:

shift_flag=shift_sched_bitmap & (1<<(log 2N−1)),

where shift_sched_bitmap indicates the bitmap of the shift schedule 206 described above, “&” represents a bitwise AND operation, and “<<” represents a left-shift operation (e.g. A<<B equals A*2^{B}). A “1” value of shift_flag indicates a right-shift is performed during the current stage, and a “0” value of shift_flag indicates a right-shift is not performed during the current stage.

A table walking circuit 210 is configured to generate a sequence 212 of phasor values to read from the phasor table 132. For example, the sequence 212 can include: phase_start, phase_start+rxs, phase_start+2*rxs, phase_start+3*rxs, etc., where phase_start indicates the start value 144.

The phasor table 132 includes P entries (where P is a positive integer), illustrated as including an entry 0 240, entry 1 241, entry 32 242, entry 64 243, and entry P-1 244. For example, as described above, each of the entries 240-244 of the phasor table 132 can correspond to one of 256 successive angles in one octant (π/4). In an illustrative implementation in which the P=256 and the table entries 240-244 store values according to:

$$Cos ( \frac{π}{4} \cdot \frac{1}{512} \cdot i ) , Sin ( \frac{π}{4} \cdot \frac{1}{512} \cdot i ) for all i ∈ \{ 1 , 3 , 5 , … , 511 \} ,$$

entry 0 240 corresponds to i=1 (e.g., phasor angle π/2048), entry 1 241 corresponds to i=3 (e.g., phasor angle 3π/2048), entry 2 corresponds to i=5 (e.g., phasor angle 5π/2048), etc., and entry P-1 244 corresponds to i=511 (e.g., phasor angle 511π/2048). Thus, the entries 240-244 are arranged in order of increasing phasor angle.

In some implementations, the set of twiddle values 150 obtained from the read-only memory 130 are arranged in a consecutive order. In an illustrative example, the entries 240-244 are arranged in the phasor table 132 in order of increasing phasor angle, and the sequence 212 is generated by iteratively incrementing (or iteratively decrementing) the start value 144, with the result that the twiddle values of the set of twiddle values 150 are read from the phasor table 132 in order of monotonically increasing (or decreasing) phasor value and are arranged in the set of twiddle values 150 in the order in which they are read from the phasor table 132.

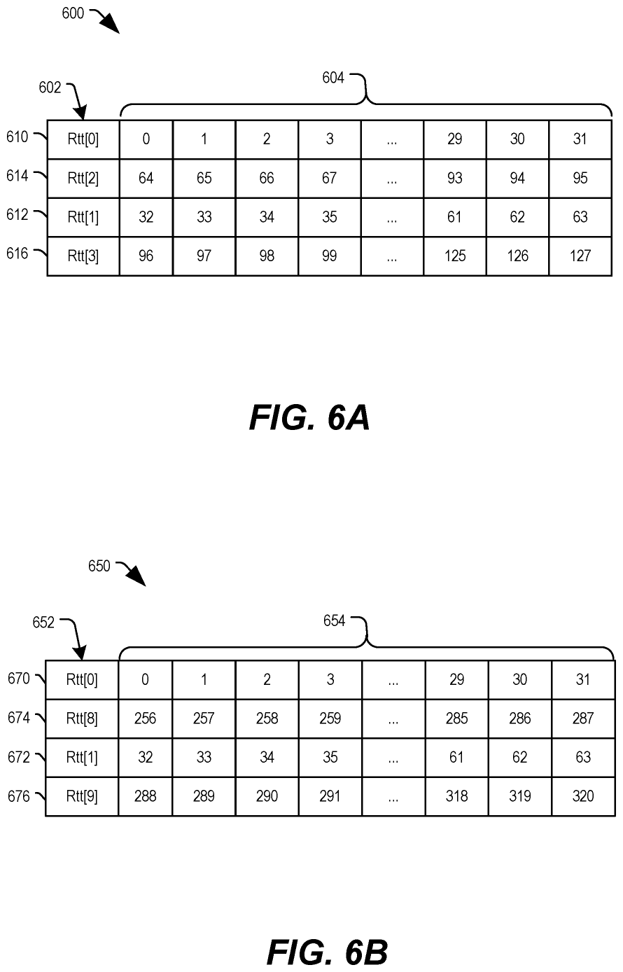

The set of twiddle values 150 are stored into one or more twiddle vector registers 220. In some implementations, the processor 190 is configured to store the set of twiddle values 150 into a single twiddle vector register 220. According to other implementations, the processor 190 is configured to store sequential portions of the set of twiddle values 150 into multiple twiddle vector registers in a manner that preserves the consecutive order of the twiddle values. In an illustrative example, if the set of twiddle values 150 includes 64 twiddle values {w₀, w₁, . . . w₆₃,} and each twiddle vector register 220 can store 32 twiddle values, the twiddle values w₀-w₃₁ are stored in consecutive order in a first twiddle vector register 220, and the twiddle values w₃₂, −w₆₃, are stored in consecutive order in a second twiddle vector register 220. In some circumstances, the processor 190 is configured to consume the sequential portions of the set of twiddle values according to the consecutive order, while in other circumstances, the processor 190 is configured to consume the sequential portions of the set of twiddle values according to a non-consecutive order. Examples of selecting twiddle vector registers in non-consecutive orders for consumption are described in further detail with reference to FIG. 6A and 6B.

Referring to FIG. 3, a particular implementation of components that may be implemented in the processor 190 is shown and designated 300. For example, the FFT instruction 122 may be executed on a set of inputs via a plurality of computation lanes. For example, the processor 190 can include M computation lanes (designated Lane 1 390, Lane 2 392, Lane 3 394, Lane 4 396, . . . Lane M 398). In a particular implementation, M=16.

Each computation lane 390-398 may include an input from a first input register Vu 302, an input from a second input register Vv 304, an input from a third input register VREG 306, and outputs to an output register Vdd 308. In a particular implementation, VREG 306 corresponds to a twiddle vector register 220 that is populated based on operation of the table walking circuit 210 reading a sequence of values from the phasor table 132. In a particular implementation, the first input register Vu 302 and the second input register Vv 304 each include N data samples. For example, the first input register Vu 302 may include sixteen (16) data samples (e.g., x0, x1 . . . x15) and the second input register Vv 304 may include sixteen (16) data samples (e.g., x32, x33 . . . x47). Thus, in this example, the first input register Vu 302 and the second input register Vv 304 each include N=16 data samples. In a particular implementation, the output register Vdd 308 includes 2N data samples. For example, the output register Vdd 308 may include 32 (i.e., 2N=32) data samples (e.g., y0, y1 . . . y31). The first input register Vu 302 and the second input register Vv 304 provide input data samples (e.g., 2 data samples at a time for radix-2 FFT) and the third input register VREG 306 provides a twiddle value (e.g., w0, w1 . . . w15) to be used in the butterfly computations of the FFT algorithm, where each twiddle value is a complex multiplicative constant (or coefficient).

During operation, butterfly computations may be performed in parallel at each of the computation lanes 390-398. In each computation lane, during each iteration, a first input data sample from the first input register Vu 302 is added to a result of multiplying a second input data sample (i.e., complex multiplication) with the twiddle value, and the result of the complex multiplication is subtracted from the first input data sample to produce outputs that are stored in the output register Vdd 308 of the computation lane. For example, Lane 1 390 includes a multiplier 320 configured to perform a multiplication operation to obtain a product of the twiddle value w0 with a second input value (i.e., x32) of the pair of input values. Lane 1 390 also includes an adder 324 configured to perform an addition operation 326 on an output of the multiplication operation (e.g., an output of the multiplier 320) and a first input value (i.e., x0) of the pair of input values to generate a first output value (y0). The adder 324 is also configured to perform a subtraction operation 328 on the output of the multiplication operation and the first input value (i.e., x0) of the pair of input values to generate a second output value (y1). Thus, the first output data 332 may be expressed as y0=x0+(x32*w0) and the second output data 334 may be expressed as y1=x0−(x32*w0). Similar computations may be performed in parallel in Lanes 2-M.

Thus, the processor 190 may combine (“shuffle”) inputs from two registers to obtain an output stored at a single output register.

Referring to FIG. 4, a particular implementation of components that may be implemented in the processor 190 is shown and designated 400. For example, the FFT instruction 122 may be executed on a set of inputs via a plurality of computation lanes. For example, the processor 190 can include M computation lanes (designated Lane 1 490, Lane 2 492, Lane 3 494, Lane 4 496, . . . Lane M 498). In a particular implementation, M=16.

Each computation lane 490-498 may include a first input register Vu 402, a second input register Vv 404, a third input register VREG 406, and an output register pair Vdd 408. In a particular implementation, VREG 406 corresponds to a twiddle vector register 220 that is populated based on operation of the table walking circuit 210 reading a sequence of values from the phasor table 132. In a particular implementation, the first input register Vu 402 and the second input register Vv 404 each include N data samples. For example, the first input register Vu 402 may include sixteen (16) data samples (e.g., x0, x2 . . . x30) and the second input register Vv 404 may include sixteen (16) data samples (e.g., x1, x3 . . . x31). Thus, in this example, the first input register Vu 402 and the second input register Vv 404 each include N=16 data samples. For example, a first output register 432 of the output register pair Vdd 408 may include 16 data samples (e.g., y0, y1 . . . y15), and a second output register 434 of the output register pair Vdd 408 may include 16 data samples (e.g., y0+M/2, y1+M/2, . . . y15+M/2). The first input register Vu 402 and the second input register Vv 404 provide input data samples (e.g., 2 data samples at a time for radix-2 FFT) and the third input register VREG 406 provides a twiddle value (e.g., w0, w1 . . . w15) to be used in the butterfly computations of the FFT algorithm, where each twiddle value is a complex multiplicative constant (or coefficient).

During operation, butterfly computations may be performed in parallel at each of the computation lanes 490-498. In each computation lane, during each iteration, a first input data sample from the first input register Vu 402 is added to a result of multiplying a second input data sample from the second input register Vv 404 with the twiddle value (i.e., complex multiplication) to produce first output data y0 that is stored in the first output register 432 of the output register pair Vdd 408. The result of the complex multiplication is also subtracted from the first input data sample to produce second output data y0+M/2 that is stored in the first output register 432 of the output register pair Vdd 408. For example, Lane 1 490 includes a multiplier 420 configured to perform a multiplication operation to obtain a product of the twiddle value w0 with a second input value (i.e., x1) of the pair of input values. Lane 1 also includes an adder 424 configured to perform an addition operation 426 on an output of the multiplication operation (e.g., an output of the multiplier 420) and a first input value (i.e., x0) of the pair of input values to generate a first output value (i.e., y0). The adder 424 is also configured to perform a subtraction operation 428 on the output of the multiplication operation and the first input value (i.e., x1) of the pair of input values to generate a second output value (i.e., y0+M/2). Thus, the first output data may be expressed as y0=x0+(x1*w0) and the second output data may be expressed as y1+M/2=x0+(x1*w0) (where M is the number of computation lanes, e.g., 16). Similar computations may be performed in parallel in Lanes 2-M.

Thus, the processor 190 may “deal” inputs from one register to obtain a first output and a second output stored at an output register pair.

FIG. 5 depicts a flow chart of a particular implementation of a multi-stage fast Fourier transform operation 500 that may be performed by the processor 190 of the system of FIG. 1. The multi-stage fast Fourier transform operation 500 includes a first stage 502, a second stage 504, and one or more additional stages including a final stage, stage S 506. The number of stages (S) corresponds to the number of input data values (N) to be processed, as N=log₂S.

In the first stage 502, the processor 190 determines a number of twiddle registers to be used for the first stage 502 and a start value (e.g., the start value 144) and a step value (e.g., the step size 146) for retrieving values from the phasor table 132 to populate each of the twiddle registers that are to be used for the first stage 502, at 510.

The processor 190 executes one or more instances of the FFT instruction 122 for stage 1, at 512. For example, when the FFT size (N₁=2¹=2) for stage 1 is sufficiently small to be performed using a single twiddle vector register 220, a single FFT instruction 122 is executed in stage 1 using a set of parameter values corresponding that corresponding to the stage number (e.g., 1), the start value 144, the step size 146, and a shift schedule (e.g., a bitmap) for the multi-stage fast Fourier transform operation 500, as explained previously. For example, a number of twiddle registers to be used in a particular stage “s” can be determined according to:

Let FFT length=N
At stage “s” ∈[1, log₂(N)]:

$${N}_{stage} = {2}^{s} \\ {Num}_{twiddles} = \frac{{N}_{stage}}{2} .$$

Thus, using twiddle registers that each store 16 twiddle values, the number of twiddle registers (Num_{twiddleVREGs}) is given as:

$${Num}_{twiddleVREGs} = \frac{{Num}_{twiddles}}{32} = \frac{{N}_{stage}}{2 \times 32} = \frac{{N}_{stage}}{64} ,$$

and the number of parameter registers (e.g., Rtt0 202 of FIG. 2) is given as:

Num_{Rtts}=Num_{twiddleVREGs}.

The twiddle vector registers for a stage can be thought of as a matrix, of dimension Num_{twiddleVREGs}×32, of complex numbers.
To illustrate, at stage 6, N_{stage}=64, Num_{Rtts}=Num_{twiddleVREGs}=1; at stage 7, N_{stage}=128, Num_{Rtts}=Num_{twiddleVREGs}=2; at stage 8, N_{stage}=256, Num_{Rtts}=Num_{twiddleVREGs}=4; at stage 9, N_{stage}=512, Num_{Rtts}=Num_{twiddleVREGs}=8; etc.

Execution of the FFT instruction 122 includes loading the twiddle register, at 516, and generating the output data for that FFT instruction 122 (e.g., performing the FFT computations 160 to generate the output data 170 of FIG. 1).

In the second stage 504, the processor 190 determines a number of twiddle registers to be used for the second stage 504 and a start value (e.g., the start value 144) and a step value (e.g., the step size 146) for retrieving values from the phasor table 132 to populate each of the twiddle registers that are to be used for the second stage 504, at 520. The processor 190 executes one or more instances of the FFT instruction 122 for stage 2, at 522. Execution of the FFT instruction(s) 122 includes loading the twiddle register(s), at 526 and generating the output data for each of the FFT instruction(s) 122.

Processing continues for successive stages in a similar manner as described above. In stage S 506, the processor 190 determines a number of twiddle registers to be used for stage S 506 and a start value (e.g., the start value 144) and a step value (e.g., the step size 146) for retrieving values from the phasor table 132 to populate each of the twiddle registers that are to be used for stage S 506, at 530. The processor 190 executes one or more instances of the FFT instruction 122 for stage S, at 532. Execution of the FFT instruction(s) 122 includes loading the twiddle register(s), at 536 and generating the output data for each of the FFT instruction(s) 122.

Thus, the processor 190 is configured to, during each particular stage of the multi-stage FFT operation 500, update the parameters 124, based on the particular stage, and execute the FFT instruction 122 to generate the output data 170 of that particular stage.

At various stages of the multi-stage fast Fourier transform operation 500, twiddle values may be re-ordered. As indicated above, at each stage:

$${Num}_{Rtts} = {Num}_{twiddleVREGs} = \frac{{N}_{stage}}{64} .$$

Also, for i∈[0, Num_{Rtts}−1],

$$phase start = - \frac{2 π}{{N}_{stage}} .$$

32i with a step

$$size = \frac{2 π}{{N}_{stage}} .$$

The sets of twiddle values stored into the twiddle registers are of the form:

$$\{ {e}^{- j \frac{2 π ( 32 i + 0 )}{{N}_{stage}}} , {e}^{- j \frac{2 π ( 32 i + 1 )}{{N}_{stage}}} , {e}^{- j \frac{2 π ( 32 i + 2 )}{{N}_{stage}}} , … , {e}^{- j \frac{2 π ( 32 i + 3 )}{{N}_{stage}}} \} .$$

However, due to FFT geometry, the twiddle registers are sometimes not selected for consumption in consecutive order. For example, for stage 6, N_{stage}=64, and a single twiddle register is used. For stage 7, N_{stage}=128, and two twiddle registers are used in consecutive order. For stage 8, N_{stage}=256, four twiddle registers are used and are consumed in the order 0, 2, 1, 3 (bit-reversed order). For stage 9, N_{stage}=512, eight twiddle registers are used and are consumed in consecutive order. For stage 10, N_{stage}=1024, sixteen twiddle registers are used and are consumed in the order 0, 8, 1, 0, . . . (shuffle order). For stage 11, N_{stage}=2048, 32 twiddle registers are used and are consumed in the order 0, 4, 8, 12, . . . (shuffle(shuffle) order). It should be understood that although the above examples describe specific numbers of twiddle registers as being used, in some implementations fewer physical twiddle registers are used than the indicated number of twiddle registers, and sets of twiddle values may be stored, consumed, and then replaced with other sets of twiddle values in each of the physical registers to reach the indicated numbers.

FIG. 6A is a diagram 600 of a particular example of a non-consecutive twiddle register consumption order that may be implemented by the system of FIG. 1. In the diagram 600, a set of four twiddle registers 602 includes Rtt[0] 610, Rtt[1] 612, Rtt[2] 614, and Rtt[3] 616 corresponding to stage 8 (N_{stage}=256). The twiddle registers 610-616 store twiddle values 604 that are indicated by each twiddle value's index number. As illustrated, 128 twiddle values are loaded into the set of twiddle registers 602 in consecutive order, with the first 32 twiddle values, having indices 0, 1, . . . , 31, in Rtt[0] 610, the next 32 twiddle values, having indices 32, 33, . . . , 63, in Rtt[1] 612, the next 32 twiddle values, having indices 64, 65, . . . , 95, in Rtt[2] 614, and the final 32 twiddle values, having indices 96, 97, . . . , 127, in Rtt[2] 616.

As illustrated, the twiddle registers 610-616 are consumed in bit-reversed order, with Rtt[0] 610 consumed first, Rtt[2] 614 consumed second, Rtt[1] 612 consumed third, and Rtt[3] consumed last.

FIG. 6B is a diagram 650 of another particular example of a non-consecutive twiddle register consumption order that may be implemented by the system of FIG. 1. In the diagram 650, four representative twiddle registers of a set of 16 twiddle registers 652 includes Rtt[0] 670, Rtt[1] 672, Rtt[8] 674, and Rtt[9] 676 corresponding to stage 10 (N_{stage}=1024). The set of twiddle registers 652 store twiddle values 654 that are indicated by index number. As illustrated, 128 twiddle values (of the 512 total twiddle values for stage 10) are loaded into the set of twiddle registers 652 in consecutive order, with the first 32 twiddle values, having indices 0, 1, . . . , 31, in Rtt[0] 670, the next 32 twiddle values, having indices 32, 33, . . . , 63, in Rtt[1] 672, the seventh set of 32 twiddle values, having indices 256, 257, . . . , 287, in Rtt[8] 674, and the eighth set of 32 twiddle values, having indices 288, 289, . . . , 320, in Rtt[9] 676.

As illustrated, the twiddle registers 670-676 are consumed in a shuffled order, with Rtt[0] 670 consumed first, Rtt[8] 674 consumed second, Rtt[1] 672 consumed third, and Rtt[9] 676 consumed fourth.

Thus, the processor 190 can, during a single multi-stage FFT operation, consume the sequential portions of a set of twiddle values according to a consecutive order in a first particular stage of a multi-stage FFT operation, such as described in the example above for stage 7, and can also consume sequential portions of a second set of twiddle values according to a non-consecutive order in a second particular stage of the multi-stage FFT operation, such as described in FIG. 6A for stage 8 and in FIG. 6B for stage 10.

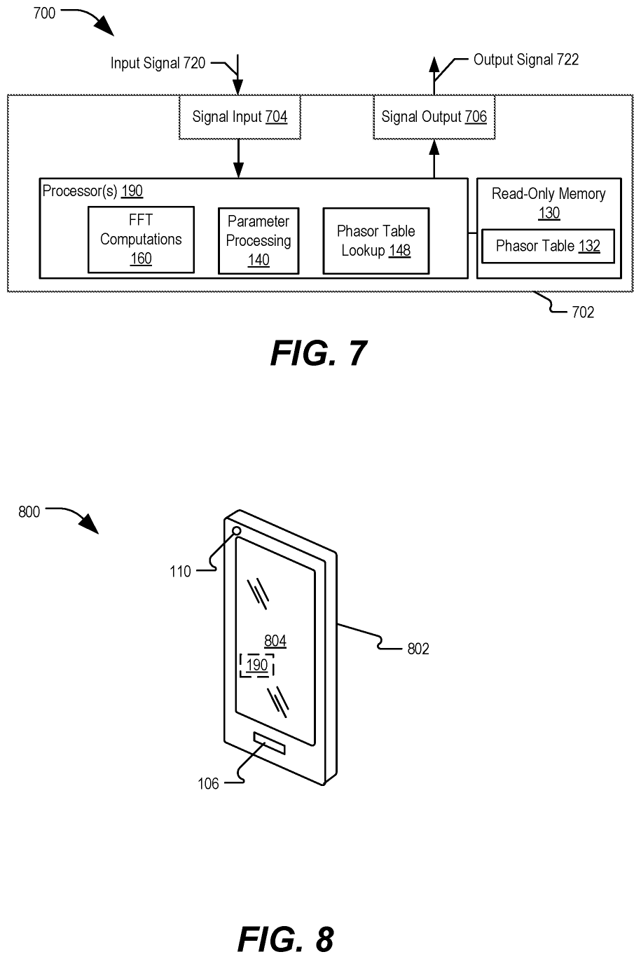

FIG. 7 depicts an implementation 700 of the device 102 as an integrated circuit 702 that includes the processor 190 and the read-only memory 130. The integrated circuit 702 also includes a signal input 704, such as one or more bus interfaces, to enable an input signal 720 (e.g., a set of samples of an audio signal to be used as the set of input data 126) to be received for processing. The integrated circuit 702 also includes a signal output 706, such as a bus interface, to enable sending of an output signal 722, such as the output data 170. The integrated circuit 702 enables implementation of FFT operations using the phasor table 132 as a component in a system that includes other components, such as a mobile phone or tablet as depicted in FIG. 8, a headset as depicted in FIG. 9, a wearable electronic device as depicted in FIG. 10, a voice-controlled speaker system as depicted in FIG. 11, a camera as depicted in FIG. 12, a virtual reality headset or an augmented reality headset as depicted in FIG. 13, or a vehicle as depicted in FIG. 14 or FIG. 15.

FIG. 8 depicts an implementation 800 in which the device 102 includes a mobile device 802, such as a phone or tablet, as illustrative, non-limiting examples. The mobile device 802 includes the microphone 106, the loudspeaker 110, and a display screen 804. Components of the processor 190 are integrated in the mobile device 802 and are illustrated using dashed lines to indicate internal components that are not generally visible to a user of the mobile device 802. In a particular example, the processor 190 performs a multi-stage FFT operation using the FFT instruction 122 to process audio signals received via the microphone 106 to generate the output data 170, which is then processed to perform one or more operations at the mobile device 802, such as to launch a graphical user interface or otherwise display other information associated with the user's speech at the display screen 804 (e.g., via an integrated “smart assistant” application). In some implementations, the device 102 includes one or more other sensors or components that generate data that can be operated on by a multi-stage FFT operation using the FFT instruction 122, such as wireless network signal data, global positioning data or other location data, video or image data from one or more cameras, inertial measurement or other movement data from an inertial measurement unit (e.g., one or more gyroscopes, compasses, accelerometers, etc.), or health data such as heart rate data, oxygen level data, respiratory data, etc. from one or more corresponding sensors, as illustrative, non-limiting examples. The multi-stage FFT operation generates output data that can be output or that can be processed to generate processed data, either or both of which may be displayed via the display screen 804, output via the loudspeaker 110, transmitted via a wireless network such as another device such as a wearable electronic device (e.g., a smart watch or headset), or output via a haptic output signal, as illustrative, non-limiting examples.

FIG. 9 depicts an implementation 900 in which the device 102 includes a headset device 902. The headset device 902 includes the microphone 106 and the loudspeaker 110. Components of the processor 190 are integrated in the headset device 902. In a particular example, the processor 190 performs a multi-stage FFT operation using the FFT instruction 122 to process audio signals received via the microphone 106 to generate the output data 170, which is then processed to cause the headset device 902 to perform one or more operations at the headset device 902.

FIG. 10 depicts an implementation 1000 in which the device 102 includes a wearable electronic device 1002, illustrated as a “smart watch.” The processor 190, the microphone 106, and the loudspeaker 110 are integrated into the wearable electronic device 1002. In a particular example, the processor 190 performs a multi-stage FFT operation using the FFT instruction 122 to process audio signals received via the microphone 106 to generate the output data 170, which is then processed to perform one or more operations at the wearable electronic device 1002, such as to launch a graphical user interface or otherwise display other information associated with the user's speech at a display screen 1004 of the wearable electronic device 1002. To illustrate, the wearable electronic device 1002 may include a display screen that is configured to display a notification based on user speech detected by the wearable electronic device 1002. In a particular example, the wearable electronic device 1002 includes a haptic device that provides a haptic notification (e.g., vibrates) in response to detection of user voice activity or generation of synthesized speech. For example, the haptic notification can cause a user to look at the wearable electronic device 1002 to see a displayed notification indicating detection of a keyword spoken by the user. The wearable electronic device 1002 can thus alert a user with a hearing impairment or a user wearing a headset that the user's voice activity is detected.

FIG. 11 is an implementation 1100 in which the device 102 includes a wireless speaker and voice activated device 1102. The wireless speaker and voice activated device 1102 can have wireless network connectivity and is configured to execute an assistant operation. The processor 190, the microphone 106, and the loudspeaker 110, are included in the wireless speaker and voice activated device 1102. During operation, in response to receiving a verbal command and performing a multi-stage FFT operation using the FFT instruction 122 to process audio signals received via the microphone 106 to generate the output data 170, which is then processed to perform one or more operations, the wireless speaker and voice activated device 1102 can process execute assistant operations, such as via execution of an integrated assistant application. The assistant operations can include adjusting a temperature, playing music, turning on lights, etc. For example, the assistant operations are performed responsive to receiving a command after a keyword or key phrase (e.g., “hello assistant”).

FIG. 12 depicts an implementation 1200 in which the device 102 includes a portable electronic device that corresponds to a camera device 1202. The processor 190, the microphone 106, or a combination thereof, are included in the camera device 1202. During operation, in response to receiving a verbal command and performing a multi-stage FFT operation using the FFT instruction 122 to process audio signals received via the microphone 106 to generate the output data 170, which is then processed to perform one or more operations, the camera device 1202 can execute operations responsive to spoken user commands, such as to adjust image or video capture settings, image or video playback settings, or image or video capture instructions, as illustrative examples.

FIG. 13 depicts an implementation 1300 in which the device 102 includes a portable electronic device that corresponds to an extended reality headset 1302, such as a virtual reality, augmented reality, or mixed reality headset. The processor 190 and the microphone 182 are integrated into the headset 1302. In a particular aspect, the headset 1302 includes the microphone 106 positioned to primarily capture speech of a user. During operation, in response to capturing user speech and performing a multi-stage FFT operation using the FFT instruction 122 to process audio signals received via the microphone 106 to generate the output data 170, which is then processed to perform one or more operations, speech detection and recognition can be performed. A visual interface device is positioned in front of the user's eyes to enable display of augmented reality or virtual reality images or scenes to the user while the headset 1302 is worn. In a particular example, the visual interface device is configured to display a notification indicating user speech detected in the audio signal.

FIG. 14 depicts an implementation 1400 in which the device 102 corresponds to, or is integrated within, a vehicle 1402, illustrated as a manned or unmanned aerial device (e.g., a package delivery drone). The processor 190 and the microphone 182 are integrated into the vehicle 1402. Speech recognition, including performing a multi-stage FFT operation using the FFT instruction 122, can be performed based on audio signals received from the microphone 106 of the vehicle 1402, such as for delivery instructions from an authorized user of the vehicle 1402.

FIG. 15 depicts another implementation 1500 in which the device 102 corresponds to, or is integrated within, a vehicle 1502, illustrated as a car. The vehicle 1502 includes the processor 190, the microphone 106, and the loudspeaker 110. The microphone 106 is positioned to capture utterances of an operator of the vehicle 1502. In some implementations, speech recognition, including performing a multi-stage FFT operation using the FFT instruction 122, can be performed based on audio signals received from the microphone 106 of the vehicle 1502. In a particular implementation, in response to receiving and recognizing a verbal command, a voice activation system initiates one or more operations of the vehicle 1502 based on one or more keywords (e.g., “unlock,” “start engine,” “play music,” “display weather forecast,” or another voice command) detected in the output data 170, such as by providing feedback or information via a display 1520 or the loudspeaker 110.

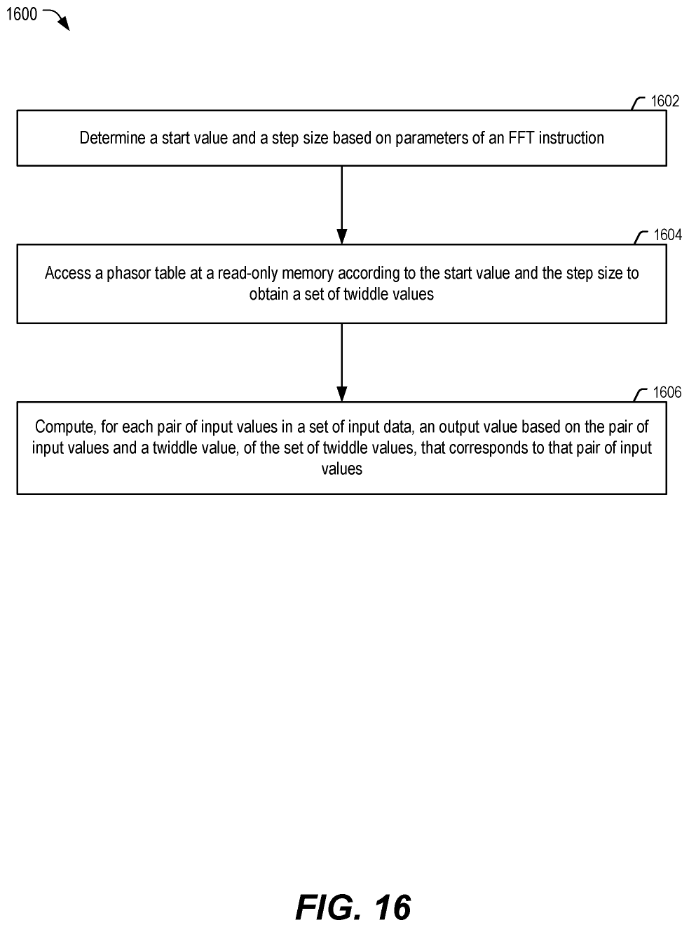

Referring to FIG. 16, a particular implementation of a method 1600 of executing a fast Fourier transform (FFT) instruction is shown. In a particular aspect, one or more operations of the method 1600 are performed by at least one of the processor 190, the device 102, the system 100 of FIG. 1, the table walking circuit 210, or a combination thereof. According to some aspects, the FFT instruction is executed as part of a multi-stage FFT operation.

The method 1600 includes determining, at a processor, a start value and a step size based on parameters of the FFT instruction, at 1602. In some implementations, the parameters of the FFT instruction include an indication of a parameter register that stores the start value and a stage number of a multi-stage FFT operation, such as the parameter register 202 that stores the start value 144 and the stage number 204. Determining the start value and the step size can include reading the start value from the parameter register and computing the step size based on the stage number, such as described with reference to determining the step size 146 based on the stage number 204. The method 1600 can also include reading a shift schedule of the multi-stage FFT operation from the parameter register. According to some aspects, the shift schedule includes a bitmap that indicates, for each stage of the multi-stage FFT operation, a presence or absence of a shift for that stage, such as described with reference to the shift schedule 206.

The method 1600 includes accessing a phasor table at a read-only memory according to the start value and the step size to obtain a set of twiddle values, at 1604. For example, the processor 190 performs the phasor table lookup operation 148 (e.g., via operation of the table walking circuit 210). In some implementations, the method 1600 includes storing the set of twiddle values into a single twiddle vector register. In other implementations, the method 1600 includes storing sequential portions of the set of twiddle values into multiple twiddle vector registers, such as described with reference to FIG. 6A and 6B.

The method 1600 includes computing, at the processor and for each pair of input values in a set of input data, an output value based on the pair of input values and a twiddle value, of the set of twiddle values, that corresponds to that pair of input values, at 1606. For example, the method 1600 can include accessing a first portion of the set of input data from a first input vector register indicated by the parameters and accessing a second portion of the set of input data from a second input vector register indicated by the parameters, such as the portions {x0, . . . , x15} and {x32, . . . , x47} accessed from the input registers Vu 302 and Vv 304, respectively, of FIG. 3. The method 1600 can include performing a multiplication operation to obtain a product of the twiddle value with a first input value of the pair of input values, performing an addition operation on an output of the multiplication operation and a second input value of the pair of input values to generate the output value, and performing a subtraction operation on the output of the multiplication operation and the second input value of the pair of input values to generate a second output value, such as described with reference to processing at the multiplier 320 and the adder 324 of Lane 1 390 of FIG. 3.

The method 1600 enables reduced local memory usage, code size, hardware ROM size, vector register pressure, or a combination thereof, by using twiddle values from a general purpose phasor table instead of from multiple specialized twiddle tables stored in memory, in ROM, or both.

The method 1600 of FIG. 16 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1600 of FIG. 16 may be performed by a processor that executes instructions, such as the processor 190.

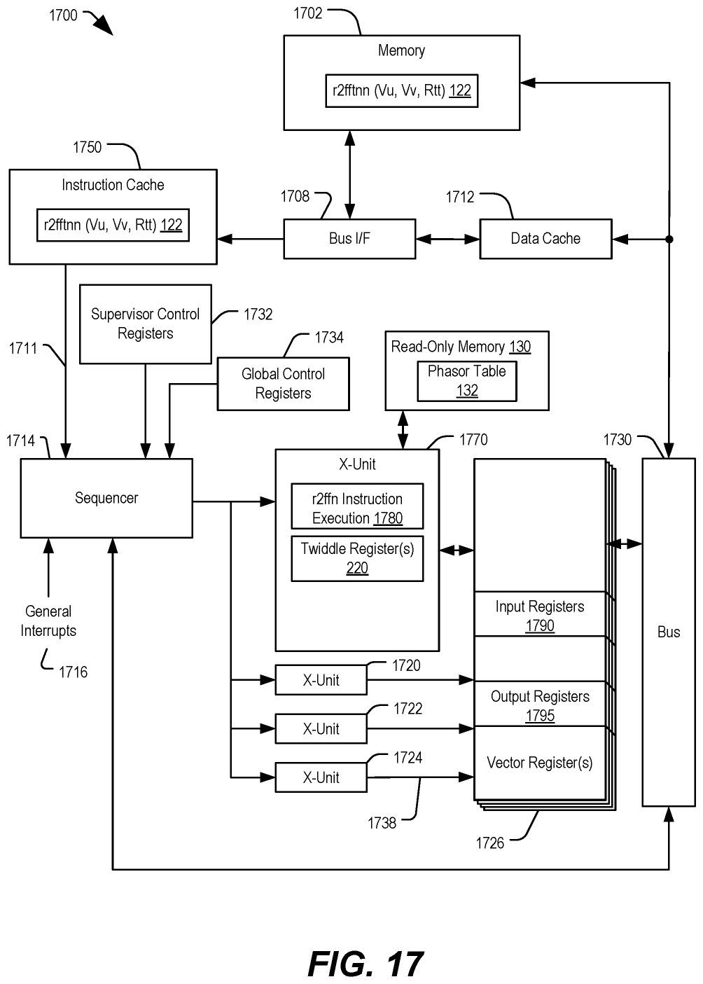

FIG. 17 depicts an implementation of a system 1700 operable to perform fast Fourier transforms using a phasor table. The system 1700 includes the read-only memory 130, a memory 1702 storing the FFT instruction 122 (e.g., r2fftnn (Vv, Vu, Rtt)) and a processor to execute the FFT instruction 122. In an illustrative example, the system 1700 is implemented in the device 102 of FIG. 1. For example, the memory 1702 may correspond to the memory 120, and the additional components illustrated in FIG. 17 that are coupled to the memory 1702 and to the read-only memory 130 are implemented in the processor 190.

The memory 1702 may be coupled to an instruction cache 1750 via a bus interface 1708. In a particular implementation, all or a portion of the system 1700 may be integrated into a processor. Alternately, the memory 1702 may be external to the processor. The memory 1702 may send FFT instruction 122 to the instruction cache 1750 via the bus interface 1708. The FFT instruction 122 may be executed on a set of inputs stored in an input register 1790 to produce output data stored in an output register 1795. Input register 1790 and output register 1795 may be part of a vector register file 1726. Alternately, the set of inputs may be stored in a data cache 1712 or the memory 1702. It should be noted that although the input registers 1790 and the output registers 1795 are illustrated separately, the input registers 1790 and the output registers 1795 may include one or more common registers (i.e., registers that function as both input and output registers). Moreover, there may be any number of input registers 1790 and output registers 1795.

The instruction cache 1750 may be coupled to a sequencer 1714 via a bus 1711. The sequencer 1714 may receive general interrupts 1716, which may be retrieved from an interrupt register (not shown). In a particular implementation, the instruction cache 1750 may be coupled to the sequencer 1714 via a plurality of current instruction registers (not shown), which may be coupled to the bus 1711 and associated with particular threads (e.g., hardware threads) of the processor. In a particular implementation, the processor may be an interleaved multi-threaded processor including six (6) threads.

In a particular implementation, the bus 1711 may be a one-hundred and twenty-eight bit (128-bit) bus and the sequencer 1714 may be configured to retrieve instructions from the instruction cache 1710 via instruction packets, including the FFT instruction 122, having a length of thirty-two (32) bits each. The bus 1711 may be coupled to a first instruction execution unit 1770, a second instruction execution unit 1720, a third instruction execution unit 1722, and a fourth instruction execution unit 1724. One or more of the execution units 1770, 1720, 1722, and 1724 may be configured to perform a FFT operations (e.g., by executing FFT instruction 122). It should be noted that there may be fewer or more than four instruction execution units. Each instruction execution unit 1770, 1720, 1722, and 1724 may be coupled to the vector register file 1726 via a second bus 1738. The vector register file 1726 may also be coupled to the sequencer 1714, the data cache 1712, and the memory 1702 via a third bus 1730. In a particular implementation, one or more of the execution units 1770, 1720, 1722, and 1724 may be load/store units.

The system 1700 may also include supervisor control registers 1732 and global control registers 1734 to store bits that may be accessed by control logic within the sequencer 1714 to determine whether to accept interrupts (e.g., the general interrupts 1716) and to control execution of instructions. The phasor table 132 of the read-only memory 130 is accessible to at least the execution unit 1770.

In a particular implementation, the instruction cache 1710 may issue the FFT instruction 122 to any of the execution units 1770, 1720, 1722, and 1724. For example, the execution unit 1770 may receive the FFT instruction 122 and may execute the FFT instruction 122 to perform a first FFT operation on a set of inputs in a time domain to produce data in a frequency domain, illustrated as an f2ffn instruction execution operation 1780. The set of inputs may be stored in any of the input registers 1790 and sent to the execution unit 1770 during execution of the first instruction. Alternately, or in addition, the set of inputs may be stored in the memory 1702 or the data cache 1712. The data in the frequency domain (i.e., the output produced from execution of the FFT instruction 122) may be stored in any of the output registers 1795.

Twiddle values associated with execution of the FFT instruction 112 are retrieved from the phasor table 132. For example, in some implementations the table walking circuit 210 is included in, or accessible to, the execution unit 1770. Twiddle values retrieved from the phasor table 132 are stored in the twiddle vector register 220 internal to the execution unit 1770, such as one or more pipeline registers or one or more dedicated twiddle vector registers, as illustrative, non-limiting examples. In other implementations, one or more twiddle vector register(s) 220 are included in the vector register file 1726.

Thus, the system 1700 of FIG. 17 may enable use of the phasor table 132 in the read-only memory 130 as a source of twiddle values for use during the r2ffn instruction execution operation 1780, instead of dedicated twiddle tables stored in the memory 1702 or in the read-only memory 130. As a result, usage of the memory 1702, the read-only memory 130, or both, may be reduced, pressure of the vector register file 1726 may be reduced, or a combination thereof.

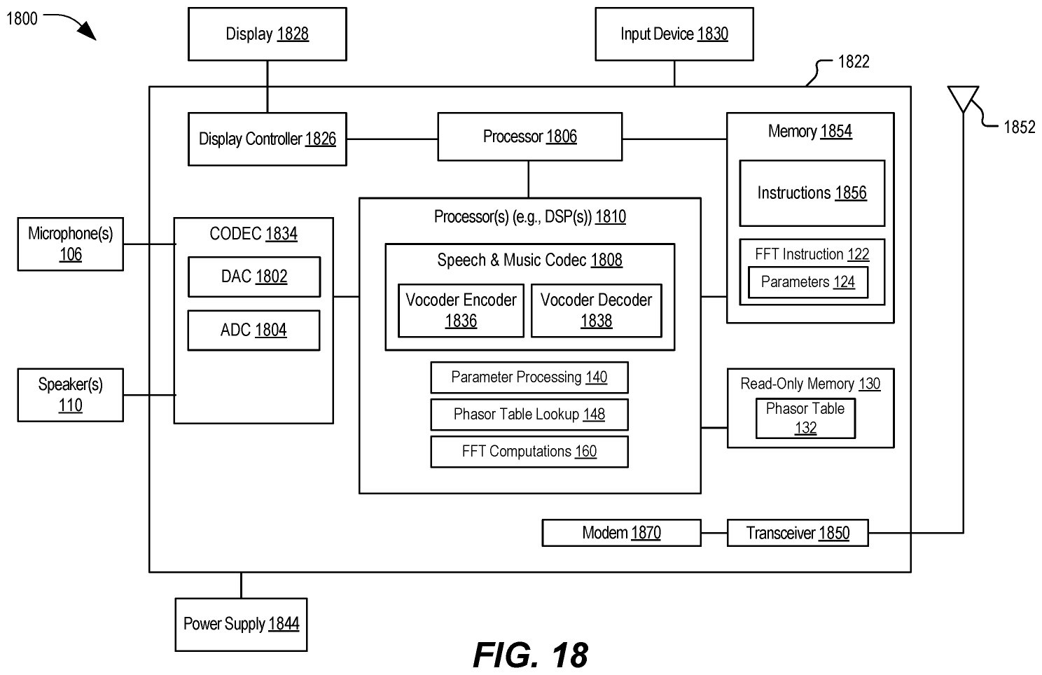

Referring to FIG. 18, a block diagram of a particular illustrative implementation of a device is depicted and generally designated 1800. In various implementations, the device 1800 may have more or fewer components than illustrated in FIG. 18. In an illustrative implementation, the device 1800 may correspond to the device 102 of FIG. 1. In an illustrative implementation, the device 1800 may perform one or more operations described with reference to FIGS. 1-17.

In a particular implementation, the device 1800 includes a processor 1806 (e.g., a central processing unit (CPU)). The device 1800 may include one or more additional processors 1810 (e.g., one or more DSPs). In a particular aspect, the processor 190 of FIG. 1 corresponds to the processor 1806, the processors 1810, or a combination thereof. The processors 1810 may include a speech and music coder-decoder (CODEC) 1808 that includes a voice coder (“vocoder”) encoder 1836 and a vocoder decoder 1838. The processors 1810 may be configured to perform the parameter processing operation 140, the phasor table lookup operation 148, the FFT computations 160, or a combination thereof. The processors 1810 are coupled to the read-only memory 130 storing the phasor table 132 for retrieval of twiddle values for use in conjunction with the FFT computations 160.

The device 1800 may include a memory 1854 and a CODEC 1834. The memory 1854 may include instructions 1856, that are executable by the one or more additional processors 1810 (or the processor 1806) to implement the functionality described with reference to the multi-stage FFT transform operation 500. The memory 1854 may also include the FFT instruction 122. The device 1800 may include a modem 1870 coupled, via a transceiver 1850, to an antenna 1852.

The device 1800 may include a display 1828 coupled to a display controller 1826. One or more speakers 186, one or more microphones 182, or both may be coupled to the CODEC 1834. The CODEC 1834 may include a digital-to-analog converter (DAC) 1802, an analog-to-digital converter (ADC) 1804, or both. In a particular implementation, the CODEC 1834 may receive analog signals from the microphone 106, convert the analog signals to digital signals using the analog-to-digital converter 1804, and provide the digital signals to the speech and music codec 1808. The speech and music codec 1808 may process the digital signals, such as via transform using the FFT instruction 122. In a particular implementation, the speech and music codec 1808 may provide digital signals to the CODEC 1834. The CODEC 1834 may convert the digital signals to analog signals using the digital-to-analog converter 1802 and may provide the analog signals to the loudspeaker 110.

The device 1800 may include a virtual assistant, a home appliance, a smart device, an internet of things (IoT) device, a communication device, a headset, a vehicle, a computer, a display device, a television, a gaming console, a music player, a radio, a video player, an entertainment unit, a personal media player, a digital video player, a camera, a navigation device, a smart speaker, a speaker bar, a mobile communication device, a smart phone, a cellular phone, a laptop computer, a tablet, a personal digital assistant, a digital video disc (DVD) player, a tuner, an augmented reality headset, a virtual reality headset, an aerial vehicle, a home automation system, a voice-activated device, a wireless speaker and voice activated device, a portable electronic device, a car, a vehicle, a computing device, a virtual reality (VR) device, a base station, a mobile device, or any combination thereof.

In conjunction with the described implementations, an apparatus includes means for determining a start value and a step size based on parameters of a fast Fourier transform instruction. In an example, the means for determining a start value and a step size based on parameters of a fast Fourier transform instruction includes the processor 190, the device 102, the execution unit 1770, the processor 1806, the one or more processors 1810, the device 1800, one or more other circuits or components configured to determine a start value and a step size based on parameters of a fast Fourier transform instruction, or any combination thereof.

The apparatus includes means for accessing a phasor table at a read-only memory according to the start value and the step size to obtain a set of twiddle values. In an example, the means for accessing a phasor table at a read-only memory according to the start value and the step size to obtain a set of twiddle values includes the processor 190, the device 102, the table walking circuit 210, the execution unit 1770, the processor 1806, the one or more processors 1810, the device 1800, one or more other circuits or components configured to access a phasor table at a read-only memory according to the start value and the step size to obtain a set of twiddle values, or any combination thereof.

The apparatus also includes means for computing, for each pair of input values in a set of input data, an output value based on the pair of input values and a twiddle value, of the set of twiddle values, that corresponds to that pair of input values. In an example, the means for computing an output value based on the pair of input values and a twiddle value includes the processor 190, the device 102, the multiplier 320, the adder 324, one or more of the computation lanes 390-398, the multiplier 420, the adder 424, one or more of the computation lanes 490-498, the execution unit 1770, the processor 1806, the one or more processors 1810, the device 1800, one or more other circuits or components configured to compute, for each pair of input values in a set of input data, an output value based on the pair of input values and a twiddle value, of the set of twiddle values, that corresponds to that pair of input values, or any combination thereof.

In some implementations, a non-transitory computer-readable medium (e.g., a computer-readable storage device, such as the memory 120, the memory 1702, or the memory 1854) includes instructions (e.g., the instructions 1856) that, when executed by one or more processors (e.g., the one or more processors 190, the system 1700, the one or more processors 1810, or the processor 1806), cause the one or more processors to, during execution of a fast Fourier transform (FFT) instruction (e.g., the FFT instruction 122), determine a start value (e.g., the start value 144) and a step size (e.g., the step size 146) based on parameters (e.g., the parameters 124) of the FFT instruction, access a phasor table (e.g., the phasor table 132) at a read-only memory (e.g., the read-only memory 130) according to the start value and the step size to obtain a set of twiddle values (e.g., the set of twiddle values 150), and compute, for each pair of input values (e.g., the input value pair 162) in a set of input data (e.g., the set of input data 126), an output value (e.g., a value in the output data 170, such as y0 or y1, or both, of FIG. 3, or y0 or y0+M/2, or both, of FIG. 4) based on the pair of input values and a twiddle value (e.g., the twiddle value 164, such as w0 of FIG. 3 or FIG. 4), of the set of twiddle values, that corresponds to that pair of input values.

Particular aspects of the disclosure are described below in a set of interrelated clauses:

According to Clause 1, a device includes: a memory configured to store a fast Fourier transform (FFT) instruction; a read-only memory including a phasor table; and a processor configured to execute the FFT instruction to: determine, based on parameters of the FFT instruction, a start value and a step size; access the phasor table according to the start value and the step size to obtain a set of twiddle values; and compute, for each pair of input values in a set of input data, an output value based on the pair of input values and a twiddle value, of the set of twiddle values, that corresponds to that pair of input values.

Clause 2 includes the device of Clause 1, wherein the processor is configured to execute the FFT instruction as part of a multi-stage FFT operation.

Clause 3 includes the device of Clause 2, wherein the parameters of the FFT instruction include an indication of a parameter register that stores: the start value; and a stage number of the multi-stage FFT operation.

Clause 4 includes the device of Clause 2 or Clause 3, wherein the parameter register further stores a shift schedule of the multi-stage FFT operation.

Clause 5 includes the device of Clause 4, wherein the shift schedule includes a bitmap that indicates, for each stage of the multi-stage FFT operation, a presence or absence of a shift for that stage.

Clause 6 includes the device of any of Clause 3 to Clause 5, wherein the processor is configured to determine the step size based on the stage number.

Clause 7 includes the device of any of Clause 2 to Clause 6, wherein the processor is configured to, during each particular stage of the multi-stage FFT operation: update the parameters based on the particular stage; and execute the FFT instruction to generate output data of that particular stage.

Clause 8 includes the device of any of Clause 1 to Clause 7, wherein the parameters further include indications of: a first input vector register that stores a first portion of the set of input data; and a second input vector register that stores a second portion of the set of input data.

Clause 9 includes the device of any of Clause 1 to Clause 8, wherein the set of twiddle values obtained from the read-only memory are arranged in a consecutive order.

Clause 10 includes the device of Clause 9, wherein the processor is configured to store the set of twiddle values into a single twiddle vector register.

Clause 11 includes the device of Clause 9, wherein the processor is configured to store sequential portions of the set of twiddle values into multiple twiddle vector registers.

Clause 12 includes the device of Clause 11, wherein the processor is configured to consume the sequential portions of the set of twiddle values according to the consecutive order.

Clause 13 includes the device of Clause 11, wherein the processor is configured to consume the sequential portions of the set of twiddle values according to a non-consecutive order.

Clause 14 includes the device of Clause 11, wherein the processor is configured to: consume the sequential portions of the set of twiddle values according to the consecutive order in a first particular stage of a multi-stage FFT operation; and consume sequential portions of a second set of twiddle values according to a non-consecutive order in a second particular stage of the multi-stage FFT operation.

Clause 15 includes the device of any of Clause 1 to Clause 14, wherein the processor is configured to: perform a multiplication operation to obtain a product of the twiddle value with a first input value of the pair of input values; perform an addition operation on an output of the multiplication operation and a second input value of the pair of input values to generate the output value; and perform a subtraction operation on the output of the multiplication operation and the second input value of the pair of input values to generate a second output value.

According to Clause 16 a method of executing a fast Fourier transform (FFT) instruction includes: determining, at a processor, a start value and a step size based on parameters of the FFT instruction; accessing a phasor table at a read-only memory according to the start value and the step size to obtain a set of twiddle values; and computing, at the processor and for each pair of input values in a set of input data, an output value based on the pair of input values and a twiddle value, of the set of twiddle values, that corresponds to that pair of input values.

Clause 17 includes the method of Clause 16, wherein the FFT instruction is executed as part of a multi-stage FFT operation.

Clause 18 includes the method of Clause 17, wherein the parameters of the FFT instruction include an indication of a parameter register that stores the start value and a stage number of the multi-stage FFT operation.

Clause 19 includes the method of Clause 18, further including determining the step size based on the stage number.

Clause 20 includes the method of Clause 17, wherein the parameters of the FFT instruction include an indication of a parameter register that stores the start value and a stage number of the multi-stage FFT operation, and wherein determining the start value and the step size includes: reading the start value from the parameter register; and computing the step size based on the stage number.

Clause 21 includes the method of any of Clause 18 to Clause 20, wherein the parameter register further stores a shift schedule of the multi-stage FFT operation.

Clause 22 includes the method of any of Clause 18 to Clause 21, further including reading a shift schedule of the multi-stage FFT operation from the parameter register.

Clause 23 includes the method of Clause 22, wherein the shift schedule includes a bitmap that indicates, for each stage of the multi-stage FFT operation, a presence or absence of a shift for that stage.

Clause 24 includes the method of any of Clause 17 to Clause 23, wherein the parameters further include indications of: a first input vector register that stores a first portion of the set of input data; and a second input vector register that stores a second portion of the set of input data.

Clause 25 includes the method of any of Clause 17 to Clause 24, further including, during each particular stage of the multi-stage FFT operation: updating the parameters based on the particular stage; and executing the FFT instruction to generate output data of that particular stage.

Clause 26 includes the method of any of Clause 16 to Clause 25, further including: accessing a first portion of the set of input data from a first input vector register indicated by the parameters; and accessing a second portion of the set of input data from a second input vector register indicated by the parameters.

Clause 27 includes the method of any of Clause 16 to Clause 26, further including storing the set of twiddle values into a single twiddle vector register.

Clause 28 includes the method of any of Clause 16 to Clause 26, further including storing sequential portions of the set of twiddle values into multiple twiddle vector registers.

Clause 29 includes the method of Clause 28, wherein the set of twiddle values obtained from the read-only memory are arranged in a consecutive order.

Clause 30 includes the method of Clause 29, further including consuming the sequential portions of the set of twiddle values according to the consecutive order.

Clause 31 includes the method of Clause 29, further including consuming the sequential portions of the set of twiddle values according to a non-consecutive order.

Clause 32 includes the method of Clause 29, further including: consuming the sequential portions of the set of twiddle values according to the consecutive order in a first particular stage of a multi-stage FFT operation; and consuming sequential portions of a second set of twiddle values according to a non-consecutive order in a second particular stage of the multi-stage FFT operation.

Clause 33 includes the method of any of Clause 16 to Clause 32, further including: performing a multiplication operation to obtain a product of the twiddle value with a first input value of the pair of input values; performing an addition operation on an output of the multiplication operation and a second input value of the pair of input values to generate the output value; and performing a subtraction operation on the output of the multiplication operation and the second input value of the pair of input values to generate a second output value.

According to Clause 34, a device including: a memory configured to store instructions; and a processor configured to execute the instructions to perform the method of any of Clause 16 to Clause 33.

According to Clause 35, a non-transitory computer-readable medium stores instructions that, when executed by a processor, cause the processor to perform the method of any of Clause 16 to Clause 33.

According to Clause 36, an apparatus includes means for carrying out the method of any of Clause 16 to Clause 33.

According to Clause 37, a non-transitory computer-readable medium stores instructions that, when executed by one or more processors, cause the one or more processors to, during execution of a fast Fourier transform (FFT) instruction: determine a start value and a step size based on parameters of the FFT instruction; access a phasor table at a read-only memory according to the start value and the step size to obtain a set of twiddle values; and compute, for each pair of input values in a set of input data, an output value based on the pair of input values and a twiddle value, of the set of twiddle values, that corresponds to that pair of input values.

Clause 38 includes the non-transitory computer-readable medium of Clause 37, wherein the parameters of the FFT instruction include an indication of a parameter register that stores the start value and a stage number of a multi-stage FFT operation, and wherein the instructions are executable to cause the one or more processors to: read the start value from the parameter register; and compute the step size based on the stage number.

Clause 39 includes the non-transitory computer-readable medium of Clause 38, wherein the instructions are executable to cause the one or more processors to read a shift schedule of the multi-stage FFT operation from the parameter register.

Clause 40 includes the non-transitory computer-readable medium of any of Clause 37 to Clause 39, wherein the instructions are executable to cause the one or more processors to execute the FFT instruction as part of a multi-stage FFT operation.

According to Clause 41, an apparatus includes: means for determining a start value and a step size based on parameters of a fast Fourier transform instruction; means for accessing a phasor table at a read-only memory according to the start value and the step size to obtain a set of twiddle values; and means for computing, for each pair of input values in a set of input data, an output value based on the pair of input values and a twiddle value, of the set of twiddle values, that corresponds to that pair of input values.

Clause 42 includes the apparatus of Clause 41, wherein the means for determining, the means for accessing, and the means for computing are integrated into at least one of a virtual assistant, a home appliance, a smart device, an internet of things (IoT) device, a communication device, a headset, a vehicle, a computer, a display device, a television, a gaming console, a music player, a radio, a video player, an entertainment unit, a personal media player, a digital video player, a camera, or a navigation device.

According to Clause 43, a device includes: a memory configured to store a fast Fourier transform (FFT) instruction and parameters of the FFT instruction; a read-only memory including a phasor table; and a processor configured to execute the FFT instruction to: determine, based on the parameters of the FFT instruction, a start value and a step size; access the phasor table according to the start value and the step size to obtain a set of twiddle values; and compute, for each pair of input values in a set of input data, an output value based on the pair of input values and a twiddle value, of the set of twiddle values, that corresponds to that pair of input values.

Clause 44 includes the device of Clause 43, wherein the processor is configured to execute the FFT instruction as part of a multi-stage FFT operation and wherein the output values are included in output data of a stage of the multi-stage FFT operation.

Clause 45 includes the device of Clause 44, wherein the parameters of the FFT instruction include an indication of a parameter register that stores: the start value; and a stage number of the multi-stage FFT operation.

Clause 46 includes the device of Clause 44 or Clause 45, wherein the parameter register further stores a shift schedule of the multi-stage FFT operation.

Clause 47 includes the device of Clause 46, wherein the shift schedule includes a bitmap that indicates, for each stage of the multi-stage FFT operation, a presence or absence of a shift for that stage.

Clause 48 includes the device of any of Clause 45 to Clause 47, wherein the processor is configured to determine the step size based on the stage number.

Clause 49 includes the device of any of Clause 44 to Clause 48, wherein the processor is configured to, during each particular stage of the multi-stage FFT operation: update the parameters based on the particular stage; and execute the FFT instruction to generate output data of that particular stage.

Clause 50 includes the device of any of Clause 43 to Clause 49, wherein the parameters further include indications of: a first input vector register that stores a first portion of the set of input data; and a second input vector register that stores a second portion of the set of input data.

Clause 51 includes the device of any of Clause 43 to Clause 50, wherein the set of twiddle values obtained from the read-only memory are arranged in a consecutive order.

Clause 52 includes the device of Clause 51, wherein the processor is configured to store the set of twiddle values into a single twiddle vector register.

Clause 53 includes the device of Clause 51, wherein the processor is configured to store sequential portions of the set of twiddle values into multiple twiddle vector registers.

Clause 54 includes the device of Clause 53, wherein the processor is configured to consume the sequential portions of the set of twiddle values according to the consecutive order.

Clause 55 includes the device of Clause 53, wherein the processor is configured to consume the sequential portions of the set of twiddle values according to a non-consecutive order.

Clause 56 includes the device of Clause 53, wherein the processor is configured to: consume the sequential portions of the set of twiddle values according to the consecutive order in a first particular stage of a multi-stage FFT operation; and consume sequential portions of a second set of twiddle values according to a non-consecutive order in a second particular stage of the multi-stage FFT operation.

Clause 57 includes the device of any of Clause 53 to Clause 56, wherein the processor is configured to: perform a multiplication operation to obtain a product of the twiddle value with a first input value of the pair of input values; perform an addition operation on an output of the multiplication operation and a second input value of the pair of input values to generate the output value; and perform a subtraction operation on the output of the multiplication operation and the second input value of the pair of input values to generate a second output value.

Clause 58 includes device of any of Clause 43 to Clause 57, wherein the memory, the read-only memory, and the processor are integrated into at least one of a mobile device, a headset device, a wearable electronic device, a wireless speaker and voice activated device, a camera device, an extended reality headset, or a vehicle.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store a fast Fourier transform (FFT) instruction and parameters of the FFT instruction;
a read-only memory including a phasor table; and
a processor configured to execute the FFT instruction to:
determine, based on the parameters of the FFT instruction, a start value and a step size;
access the phasor table according to the start value and the step size to obtain a set of twiddle values; and
compute, for each pair of input values in a set of input data, an output value based on the pair of input values and a twiddle value, of the set of twiddle values, that corresponds to that pair of input values.

2. The device of claim 1, wherein the processor is configured to execute the FFT instruction as part of a multi-stage FFT operation and wherein the output values are included in output data of a stage of the multi-stage FFT operation.

3. The device of claim 2, wherein the parameters of the FFT instruction include an indication of a parameter register that stores:
the start value; and
a stage number of the multi-stage FFT operation.

4. The device of claim 3, wherein the parameter register further stores a shift schedule of the multi-stage FFT operation.

5. The device of claim 4, wherein the shift schedule includes a bitmap that indicates, for each stage of the multi-stage FFT operation, a presence or absence of a shift for that stage.

6. The device of claim 3, wherein the parameters further include indications of:
a first input vector register that stores a first portion of the set of input data; and
a second input vector register that stores a second portion of the set of input data.

7. The device of claim 3, wherein the processor is configured to determine the step size based on the stage number.

8. The device of claim 2, wherein the processor is configured to, during each particular stage of the multi-stage FFT operation:
update the parameters based on the particular stage; and
execute the FFT instruction to generate output data of that particular stage.

9. The device of claim 1, wherein the set of twiddle values obtained from the read-only memory are arranged in a consecutive order.

10. The device of claim 9, wherein the processor is configured to store the set of twiddle values into a single twiddle vector register.

11. The device of claim 9, wherein the processor is configured to store sequential portions of the set of twiddle values into multiple twiddle vector registers.

12. The device of claim 11, wherein the processor is configured to consume the sequential portions of the set of twiddle values according to the consecutive order.

13. The device of claim 11, wherein the processor is configured to consume the sequential portions of the set of twiddle values according to a non-consecutive order.

14. The device of claim 11, wherein the processor is configured to:
consume the sequential portions of the set of twiddle values according to the consecutive order in a first particular stage of a multi-stage FFT operation; and
consume sequential portions of a second set of twiddle values according to a non-consecutive order in a second particular stage of the multi-stage FFT operation.

15. The device of claim 1, wherein the processor is configured to:
perform a multiplication operation to obtain a product of the twiddle value with a first input value of the pair of input values;
perform an addition operation on an output of the multiplication operation and a second input value of the pair of input values to generate the output value; and
perform a subtraction operation on the output of the multiplication operation and the second input value of the pair of input values to generate a second output value.

16. The device of claim 1, wherein the memory, the read-only memory, and the processor are integrated into at least one of a mobile device, a headset device, a wearable electronic device, a wireless speaker and voice activated device, a camera device, an extended reality headset, or a vehicle.

17. A method of executing a fast Fourier transform (FFT) instruction, comprising:
determining, at a processor, a start value and a step size based on parameters of the FFT instruction;
accessing a phasor table at a read-only memory according to the start value and the step size to obtain a set of twiddle values; and
computing, at the processor and for each pair of input values in a set of input data, an output value based on the pair of input values and a twiddle value, of the set of twiddle values, that corresponds to that pair of input values.

18. The method of claim 17, wherein the FFT instruction is executed as part of a multi-stage FFT operation.

19. The method of claim 18, wherein the parameters of the FFT instruction include an indication of a parameter register that stores the start value and a stage number of the multi-stage FFT operation, and wherein determining the start value and the step size includes:
reading the start value from the parameter register; and
computing the step size based on the stage number.

20. The method of claim 19, further comprising reading a shift schedule of the multi-stage FFT operation from the parameter register.

21. The method of claim 20, wherein the shift schedule includes a bitmap that indicates, for each stage of the multi-stage FFT operation, a presence or absence of a shift for that stage.

22. The method of claim 19, further comprising:
accessing a first portion of the set of input data from a first input vector register indicated by the parameters; and
accessing a second portion of the set of input data from a second input vector register indicated by the parameters.

23. The method of claim 17, further comprising storing the set of twiddle values into a single twiddle vector register.

24. The method of claim 17, further comprising storing sequential portions of the set of twiddle values into multiple twiddle vector registers.

25. The method of claim 17, further comprising:
performing a multiplication operation to obtain a product of the twiddle value with a first input value of the pair of input values;
performing an addition operation on an output of the multiplication operation and a second input value of the pair of input values to generate the output value; and
performing a subtraction operation on the output of the multiplication operation and the second input value of the pair of input values to generate a second output value.

26. A non-transitory computer-readable medium storing instructions that, when executed by one or more processors, cause the one or more processors to, during execution of a fast Fourier transform (FFT) instruction:
determine a start value and a step size based on parameters of the FFT instruction;
access a phasor table at a read-only memory according to the start value and the step size to obtain a set of twiddle values; and
compute, for each pair of input values in a set of input data, an output value based on the pair of input values and a twiddle value, of the set of twiddle values, that corresponds to that pair of input values.

27. The non-transitory computer-readable medium of claim 26, wherein the parameters of the FFT instruction include an indication of a parameter register that stores the start value and a stage number of a multi-stage FFT operation, and wherein the instructions are executable to cause the one or more processors to:
read the start value from the parameter register; and
compute the step size based on the stage number.

28. The non-transitory computer-readable medium of claim 27, wherein the instructions are executable to cause the one or more processors to read a shift schedule of the multi-stage FFT operation from the parameter register.

29. The non-transitory computer-readable medium of claim 26, wherein the instructions are executable to cause the one or more processors to execute the FFT instruction as part of a multi-stage FFT operation.

30. An apparatus comprising:
means for determining a start value and a step size based on parameters of a fast Fourier transform instruction;
means for accessing a phasor table at a read-only memory according to the start value and the step size to obtain a set of twiddle values; and
means for computing, for each pair of input values in a set of input data, an output value based on the pair of input values and a twiddle value, of the set of twiddle values, that corresponds to that pair of input values.
